(19) United States
(12) Patent Application Publication
(10) Pub. No.: US 2025/0386872 A1
(43) Pub. Date: Dec. 25, 2025

(54) AEROSOL GENERATING DEVICE

(71) Applicant: KT&G CORPORATION, Daejeon (KR)

(72) Inventors: Hyung Jin JUNG, Seoul (KR); Ju Eon PARK, Gyeonggi-do (KR); Youn Ji SHIN, Seoul (KR); Jong Sub LEE, Gyeonggi-do (KR); Hun Il LIM, Seoul (KR)

(73) Assignee: KT&G CORPORATION, Daejeon (KR)

(21) Appl. No.: 19/097,129

(22) Filed: Apr. 1, 2025

(30) Foreign Application Priority Data
Jun. 25, 2024 (KR) 10-2024-0083116
Sep. 3, 2024 (KR) 10-2024-0119568

(51) Int. Cl. A24F 40/53; A24F 40/20; A24F 40/465; A24F 40/51; A24F 40/57; H05B 6/10

(52) U.S. Cl. CPC A24F 40/53; A24F 40/20; A24F 40/465; A24F 40/51; A24F 40/57; H05B 6/105; H05B 2213/05

(57) ABSTRACT

Provided is an aerosol generating device including a heater configured to heat an aerosol generating article accommodated in a cavity, an inductor unit including at least one inductor surrounding at least a portion of the cavity, and having an inductance that varies when the aerosol generating article is accommodated in the cavity, an inductor unit including at least one capacitor surrounding a remaining portion of the cavity, and having a capacitance that varies when the aerosol generating article is accommodated in the cavity, and a controller configured to obtain a first monitoring value corresponding to a change in the inductance and a second monitoring value corresponding to a change in the capacitance, and, based on at least one of the first monitoring value and the second monitoring value, determine whether the aerosol generating article is accommodated in the cavity.

### CROSS-REFERENCE TO RELATED APPLICATION

This application is based on and claims priority under 35 U.S.C. § 119 to Korean Patent Application No. 10-2024-0083116, filed on Jun. 25, 2024, and Korean Patent Application No. 10-2024-0119568, filed on Sep. 3, 2024, in the Korean Intellectual Property Office, the disclosures of which are incorporated by reference herein in their entirety.

### BACKGROUND

### 1. Field

The disclosure relates to aerosol generating devices, and more particularly, to an aerosol generating device capable of accurately detecting whether an aerosol generating substrate is inserted, while reducing power consumption.

### 2. Description of the Related Art

Recently, there has been an increasing demand for an alternative method of overcoming the disadvantages of normal cigarettes. For example, there is an increasing demand for a system for generating aerosols by heating an aerosol generating substrate by using an aerosol generating device, rather than by burning cigarettes.

Such an aerosol generating device may provide user convenience by including a sensor for detecting an aerosol generating substrate and automatically heating a heater when the aerosol generating substrate is inserted into the aerosol generating device. Conventional aerosol generating devices determine whether an aerosol generating substrate is inserted, by using only one of an inductive sensor or a capacitive sensor, leading to a significant reduction in accuracy. In addition, in conventional aerosol generating devices, components for determining changes in inductance or capacitance exist as components separate from a processor, leading to an increase in power consumption.

### SUMMARY

Provided is an aerosol generating device capable of accurately detecting whether an aerosol generating substrate is inserted, while reducing power consumption.

Technical objectives of embodiments are not limited to the above-described technical objectives and other technical objectives may be derived from the embodiments to be described hereinafter.

Additional aspects will be set forth in part in the description which follows and, in part, will be apparent from the description, or may be learned by practice of the presented embodiments of the disclosure.

According to an embodiment, an aerosol generating device may include a heater configured to heat an aerosol generating article accommodated in a cavity, an inductor unit including at least one inductor surrounding at least a portion of the cavity, and having an inductance that varies when the aerosol generating article is accommodated in the cavity, a capacitor unit including at least one capacitor surrounding a remaining portion of the cavity, and having a capacitance that varies when the aerosol generating article is accommodated in the cavity, and a controller configured to obtain a first monitoring value corresponding to a change in the inductance and a second monitoring value corresponding to a change in the capacitance, and, based on at least one of the first monitoring value and the second monitoring value, determine whether the aerosol generating article is accommodated in the cavity.

### BRIEF DESCRIPTION OF THE DRAWINGS

The above and other aspects, features, and advantages of certain embodiments of the inventive concept will be more apparent from the following description taken in conjunction with the accompanying drawings, in which:

FIG. 1 is a block diagram of an aerosol generating device according to an embodiment;

FIG. 2 illustrates an aerosol generating device according to an embodiment;

FIG. 3 illustrates an aerosol generating device according to an embodiment;

FIG. 4 illustrates an aerosol generating device according to an embodiment;

FIG. 5 is a cross-sectional view of a heater assembly for explaining an arrangement of an inductor and a capacitor, according to an embodiment;

FIG. 6 is a drawing for explaining an inductor and a capacitor formed integrally with each other;

FIG. 7 is a block diagram of an internal structure of a controller according to an embodiment;

FIG. 8 is a drawing for explaining a method of obtaining a first monitoring value corresponding to a change in inductance, according to an embodiment;

FIG. 9 illustrates graphs for explaining a method of determining a frequency change of FIG. 8;

FIG. 10 is a drawing for explaining a method of obtaining a second monitoring value corresponding to a change in capacitance, according to an embodiment;

FIG. 11 is a graph for explaining a method of determining a change in a full-charge time period of FIG. 10;

FIG. 12 is a diagram for explaining obtainment of a counting value representing capacitance of a capacitor unit, according to an embodiment;

FIG. 13 is a graph for explaining a relationship between a counting value and a full-charge time period, according to an embodiment;

FIG. 14 is a graph for explaining a method of determining insertion or non-insertion of an aerosol generating article by using a counting value representing a change in capacitance, according to an embodiment; and

FIG. 15 is a flowchart of an operation method of an aerosol generating device, according to an embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “-er”, and “-or” for the components used in the following description are given or used interchangeably by considering only the ease of writing the description, and do not have distinct meanings or roles in themselves. The suffix “module” or “unit”, as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

Various embodiments of the present disclosure may be implemented as software including one or more instructions stored in a storage medium (e.g., a memory 17) readable by a machine (e.g., an aerosol generating device 1). For example, a processor (e.g., a controller 12) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored.

In the present disclosure, a direction of the aerosol generating device 1 may be defined based on an orthogonal coordinate system. The x-axis direction in the orthogonal coordinate system may be defined as a left-right direction of the aerosol generating device 1. The y-axis direction may be defined as a front-back direction of the aerosol generating device 1. The z-axis direction may be defined as an upward and downward direction of the aerosol generating device 1.

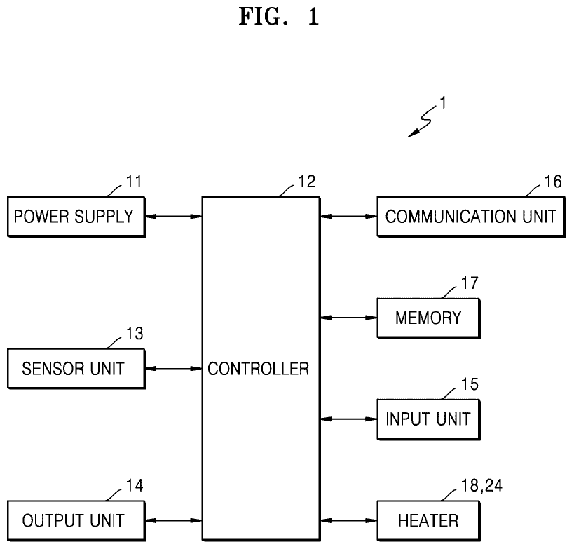

FIG. 1 is a block diagram of the aerosol generating device 1 according to an embodiment.

According to an embodiment, the aerosol generating device 1 may include a power supply 11, the controller 12, a sensor unit 13, an output unit 14, an input unit 15, a communication unit 16, a memory 17, and/or a heater 18 or 24. However, it may be understood by those skilled in the art that some of the components shown in FIG. 1 may be omitted or new components may be added, according to the design of the aerosol generating device 1.

According to an embodiment, the sensor unit 13 may sense a state of the aerosol generating device 1 or a state of the surroundings of the aerosol generating device 1 and may transmit information corresponding to the sensed state to the controller 12. For example, the sensor unit 13 may include a temperature sensor, a puff sensor, an insertion detection sensor, a reuse detection sensor, an overwetting detection sensor, a cigarette identification sensor, a cartridge detection sensor, a cap detection sensor, and/or a movement detection sensor. The sensor unit 13 may further include various sensors, such as a liquid remaining amount sensor for detecting the liquid remaining amount of a cartridge and an immersion sensor for detecting immersion of the aerosol generating device 1.

According to an embodiment, the temperature sensor may detect a temperature to which the heater 18 or 24 is heated. The aerosol generating device 1 may include a separate temperature sensor for detecting a temperature of the heater 18 or 24, or the heater 18 or 24 may serve as a temperature sensor. For example, the temperature sensor may be used to measure impedance of the heater 18. The impedance of the heater 18 may be correlated with the temperature of the heater 18. The temperature sensor may measure a current and/or voltage applied to the heater 18 (or an induction coil). Based on the measured current and/or voltage, the impedance for the heater 18 may be calculated. The controller 12 may estimate the temperature of the heater 18, based on the calculated impedance.

For example, the temperature sensor may include a resistive element (e.g., a thermistor) whose resistance value changes in response to a change in temperature of the heater 18 or 24. The temperature sensor may output a signal corresponding to the resistance value of the resistive element, and the controller 12 may detect the temperature and/or temperature change of the heater 18 or 24, based on the signal corresponding to the resistance value.

As another example, the temperature sensor may include a sensor for detecting the resistance value of the heater 18 or 24. The temperature sensor may an output signal corresponding to the resistance value of the heater 18 or 24, and the controller 12 may detect the temperature and/or temperature change of the heater 18 or 24, based on the signals corresponding to the resistance values.

According to an embodiment, the temperature sensor may detect a temperature of the power supply 11. The temperature sensor may be disposed adjacent to the power supply 11. For example, the temperature sensor may be attached to one surface of the power supply 11 (e.g., a battery) and/or mounted on one surface of a printed circuit board. For example, the aerosol generating device 1 may include a power protection circuit module (PCM), and the temperature sensor may be disposed adjacent to the power supply 11 together with the power PCM.

According to an embodiment, the temperature sensor may be disposed inside a housing (not shown) of the aerosol generating device 1 to detect an internal temperature of the housing.

According to an embodiment, the puff sensor may detect a puff of a user.

For example, the puff sensor may include a pressure sensor. The pressure sensor may output a signal corresponding to an internal pressure of the aerosol generating device 1, and the controller 12 may detect the puff of the user, based on the signal corresponding to the internal pressure. The internal pressure of the aerosol generating device 1 may correspond to pressure of an airflow path along which gas flows. The puff sensor may be disposed to correspond to the airflow path along which gas flows, in the aerosol generating device 1.

As another example, the puff sensor may include a temperature sensor. When the user' puff occurs, a temporary temperature drop may occur in the airflow path, a space where an aerosol generating article is inserted (hereinafter, an insertion space), the heater 18 or 24, etc. The controller 12 may detect the user's puff, based on a signal corresponding to the temperature of the airflow path, etc. output from the temperature sensor.

As another example, the puff sensor may include both a pressure sensor and a temperature sensor. In this case, the temperature sensor may measure a temperature that is used to correct an internal pressure measured by the pressure sensor. For example, the puff sensor may correct the signal corresponding to the internal pressure, based on the temperature measured by the temperature sensor, and may output the corrected signal. As another example, the puff sensor may output the signal corresponding to the temperature measured by the temperature sensor, and the signal corresponding to the internal pressure measured by the puff sensor. In this case, the controller 12 may receive the signals, and may correct the signal corresponding to the internal pressure, based on the signal corresponding to the temperature.

As another example, the puff sensor may include a capacitance sensor. In the present disclosure, the capacitance sensor may also be referred to as a cap sensor or a capacitive sensor. When the user's puff occurs, a temperature change and/or aerosol flow may occur within the insertion space of the aerosol generating article, and accordingly, an internal permittivity of the insertion space may change. The controller 12 may detect the user's puff, based on a signal corresponding to the internal permittivity, etc. of the insertion space output by the temperature sensor.

The puff sensor is not limited to the aforementioned examples, and may be implemented using various sensors for detecting the user's puff.

According to an embodiment, the insertion detection sensor may detect insertion and/or removal of the aerosol generating article. The insertion detection sensor may be provided around the insertion space. The insertion detection sensor may also include any combination of the aforementioned examples.

For example, the insertion detection sensor may include a capacitance sensor. The capacitance sensor may include at least one conductor. The at least one conductor may be arranged adjacent to the insertion space. When the aerosol generating article is inserted into or removed from the insertion space, a permittivity around the conductor may change. The controller 12 may detect the insertion and/or removal of the aerosol generating article, based on a signal corresponding to the internal permittivity, etc. of the insertion space output by the capacitance sensor.

As another example, the insertion detection sensor may include an inductive sensor. The inductive sensor may include at least one coil. The at least one coil may be disposed adjacent to the insertion space. When the aerosol generating article (e.g., a wrapper of the aerosol-generating article) includes a conductor and is inserted into or removed from the insertion space, a change in a magnetic field may occur around a coil where a current flows. The controller 12 may detect insertion and/or removal of the aerosol generating article including the conductor, based on the characteristics (e.g., a frequency, a current value, a voltage value, an inductance value, and an impedance value of an alternating current) of a current output or detected by the inductive sensor. Alternatively, the aerosol generating article (e.g., a medium portion of the aerosol generating article) may include a susceptor (SUS), etc. Even in this case, a change in the magnetic field around the coil may occur based on the insertion or removal of the susceptor, etc. within the insertion space, and the controller 12 may also detect the insertion and/or removal of the aerosol generating article, based on the characteristics of the current of the inductive sensor.

The insertion detection sensor is not limited to the aforementioned examples, and may be implemented using any of various sensors (e.g., a proximity sensor) for detecting insertion and/or removal of the aerosol generating article. The insertion detection sensor may also include any combination of the aforementioned examples. According to an embodiment, the insertion detection sensor may include a switch, etc. for detecting compression performed by the aerosol generating article.

According to an embodiment, the reuse detection sensor may detect whether the aerosol generating article is reused. For example, the reuse detection sensor may be a color sensor for detecting a color of the aerosol generating article. When the aerosol generating article is used by the user, a change in the color of a portion of the wrapper surrounding the outside of the aerosol generating article may occur due to generated aerosol or heating. The color sensor may output a signal corresponding to optical characteristics (e.g., a wavelength of light) corresponding to the color of the wrapper, based on light reflected by the wrapper. When a change in the color of the portion of the wrapper is detected, the controller 12 may determine that the aerosol generating article inserted into the insertion space has already been used.

According to an embodiment, the overwetting detection sensor may detect whether the aerosol generating article is in an overwetting state. For example, the overwetting detection sensor may include a capacitance sensor. The capacitance sensor may include at least one conductor disposed adjacent to the insertion space. The controller 12 may detect whether the aerosol generating article is in an overwetting state, based on the level of a signal corresponding to a permittivity, etc. output by the capacitance sensor. For example, the controller 12 may check a level range including the level of the signal, based on a look-up table, and may determine a moisture content for the aerosol generating article, based on the checked level range.

According to an embodiment, the cigarette identification sensor may detect whether the aerosol generating article is authentic, and/or detect the type of the aerosol generating article.

For example, the cigarette identification sensor may include an optical sensor for detecting an identification material (or an identification mark) located on an outer surface (e.g., a wrapper) of the aerosol generating article. The optical sensor may radiate light toward the identification material (or the identification mark) of the aerosol generating article, and may detect the authenticity and/or the type of the aerosol generating article, based on the reflected light. For example, the identification material may include a material that emits light of a wavelength in a specific band, based on the radiated light. The controller 12 may detect the authenticity and/or the type of the aerosol generating article, based on the range of the wavelength.

As another example, the cigarette identification sensor may include a capacitance sensor. According to the types of aerosol generating article inserted into the insertion space, the internal permittivity of the insertion space may vary. The controller 12 may detect the authenticity of and/or the type of the aerosol generating article, based on the signal corresponding to the internal permittivity, etc. of the insertion space output by the capacitance sensor.

As another example, the cigarette identification sensor may include an inductive sensor. When a conductor is included in the wrapper and/or interior (e.g., a medium portion) of the aerosol generating article inserted into the insertion space, the characteristics of a current detected by the inductive sensor (e.g., a frequency, a current value, a voltage value, an inductance value, and an impedance value of an AC current) may differ according to the types of aerosol generating article inserted into the insertion space. The controller 12 may detect the authenticity and/or the type of the aerosol generating article, based on the characteristics of a current output by the capacitance sensor or detected by the inductive sensor.

The cigarette identification sensor is not limited to the aforementioned examples, and may be implemented using any of various sensors for detecting whether the aerosol generating article is authentic, and/or detecting the type of the aerosol generating article. The cigarette identification sensor may also include any combination of the aforementioned examples.

According to an embodiment, the cartridge detection sensor may detect insertion and/or removal of the cartridge. For example, the cartridge detection sensor may include an inductive sensor, a capacitance sensor, a resistance sensor, a hall sensor (a hall IC) using a hall effect, and/or an optical sensor.

According to an embodiment, the cap detection sensor may detect insertion and/or removal of the cap. For example, the cap detection sensor may include an inductive sensor, a capacitance sensor, a resistance sensor, a hall sensor (a hall IC), and/or an optical sensor. The cap may include a structure that covers at least a portion of the cartridge mounted on or inserted into the aerosol generating device 1 or covers at least a portion of the housing of the aerosol generating device 1. When the cap is mounted on or removed from the housing, the cap detection sensor may output a signal corresponding to the mounting or removal of the cap. The controller 12 may detect the mounting or removal of the cap, based on a signal corresponding to the mounting or removal.

According to an embodiment, the movement detection sensor may detect a motion of the aerosol generating device 1. The movement detection sensor may be implemented using at least one of an acceleration sensor and a gyro sensor.

According to an embodiment, the sensor unit 13 may further include at least one of a humidity sensor, a pressure sensor, a magnetic sensor, a global positioning sensor (GPS), or a proximity sensor, in addition to the above-described sensors. Functions of the sensors would be instinctively understood by one of ordinary skill in the art in view of their names and thus detailed descriptions thereof will be omitted herein.

According to an embodiment, the output unit 14 may output information about the state of the aerosol generating device 1. The output unit 14 may include a display, a haptic unit, and/or a sound output unit, but embodiments are not limited thereto. For example, information about the aerosol generating device 1 may include a charging/discharging state of the power supply 11 of the aerosol generating device 1, a preheating state of the heater 18 or 24, an insertion/removal state of the aerosol generating article and/or the cartridge, a mounting and/or removal state of the cap, or a state in which use of the aerosol generating device 1 is limited (e.g., detection of an abnormal article). The display may visually provide the information about the state of the aerosol generating device 1 to the user. For example, the display may include a light-emitting diode (LED), a liquid crystal display (LCD), an organic light-emitting diode (OLED), etc. When the display includes a touch pad, the display may also be used as an input unit 15. A haptic unit may tactually provide the information about the state of the aerosol generating device 1 to the user. For example, the haptic unit may include a vibration motor, a piezoelectric element, an electrical stimulation device, etc. The sound output unit may acoustically provide the information about the aerosol generating device 1 to the user. For example, the sound output unit may convert an electrical signal into a sound signal and may output the sound signal to the outside.

According to an embodiment, the power supply 11 may output power for operating the aerosol generating device 1. The power supply 11 may include one or more batteries. The power supply 11 may supply power so that the heater 18 or 24 may be heated. In addition, the power supply 11 may supply power required for operations of the controller 12, the sensor unit 13, the output unit 14, the input unit 15, the communication unit 16, the memory 17, etc. which are other components included in the aerosol generating device 1. The power supply 11 may be a rechargeable battery or a disposable battery. For example, the power supply 11 may be a lithium polymer (LiPoly) battery, but embodiments are not limited thereto. The power supply 11 may be a rechargeable (separate-type) battery (hereinafter, a detachable battery. The detachable battery may be mounted on a battery accommodation part provided within the aerosol generating device 1, or may be removed from the battery accommodation part. The detachable battery may be charged either via wire or wirelessly.

According to an embodiment, the heater 18 or 24 may heat a medium and/or an aerosol generating material within the aerosol generating article and/or the cartridge by receiving power from the power supply 11. The aerosol generating device 1 may include a heater 18 for heating the aerosol generating article and/or a cartridge heater 24 for heating the cartridge (i.e., a solid and/or liquid medium).

According to an embodiment, the heater 18 or 24 may be electro-resistive heaters. For example, the electro-resistive heaters may include an electro-resistive material, such as a metal including titanium, zirconium, tantalum, platinum, nickel, cobalt, chromium, hafnium, niobium, molybdenum, tungsten, tin, gallium, manganese, iron, copper, stainless steel, nichrome, or the like, or a metal alloy. The electro-resistive heaters may be implemented using a metal heating wire, a metal heating plate on which an electric conductive track is disposed, a ceramic heating body, or the like.

According to an embodiment, the heater 18 or 24 may be induction heating heaters. For example, the induction heating heaters may include a susceptor that generates heat through a magnetic field. The magnetic field may be generated from an induction coil by an AC current flowing through the induction coil. The generated magnetic field may penetrate a heater and an eddy current may be generated by the susceptor. The susceptor may be heated based on the generation of the eddy current. According to an embodiment, the susceptor may be included within the aerosol generating article (e.g., the medium portion). Even in this case, the susceptor included within the aerosol generating article may be heated by the induction coil.

The heater 18 or 24 are not limited to the aforementioned examples, and may include or be replaced with various heating methods, structures, components, etc. for heating the aerosol generating article and/or the cartridge.

According to an embodiment, the input unit 15 may receive information input by the user. For example, the input unit 15 may include a touch panel, a button, a keypad, a dome switch, a jog wheel, a jog switch, etc.

According to an embodiment, the memory 17 is hardware for storing various kinds of data processed in the aerosol generating device 1, and may store pieces of data that have been processed and are to be processed by the controller 12. For example, the memory 17 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. For example, the memory 17 may store data about an operating time of the aerosol generating device 1, a maximum number of puffs, a current number of puffs, at least one temperature profile, and the user's smoking pattern.

According to an embodiment, the communication unit 16 may include at least one component for communication with another electronic device (e.g., a portable electronic apparatus). For example, the communication unit 16 may include a Bluetooth communication unit, a Bluetooth Low Energy (BLE) communication unit, an Near Field Communication (NFC) communication unit, a wireless local area network (WLAN) communication unit, a ZigBee communication unit, an infrared Data Association (IrDA) communication unit, a Wireless Fidelity Direct (WFD) communication unit, an ultra wideband (UWB) communication unit, an Adaptive Network Topology (Ant)+ communication unit, a cellular network communication unit, an Internet communication unit, a computer network (e.g., a LAN or WAN) communication unit, etc.

According to an embodiment, the controller 12 may control overall operations of the aerosol generating device 1. For example, the controller 12 may include at least one processor. The controller 12 may be implemented as an array of a plurality of logic gates, or as a combination of a general-use micro controller unit (MCU) (or a microprocessor) and a memory in which a program executable by the general-use MCU is stored. It will also be understood by one of ordinary skill in the art to which the present embodiment pertains that the controller 12 may be implemented as other types of hardware.

According to an embodiment, the controller 12 may control supplying of the power of the power supply 11 to the heater 18 or 24, thereby controlling the temperature of the heater 18 or 24. The controller 12 may control the temperature of the heater 18 or 24 and/or power supplied to the heater 18 or 24, based on the temperature of the heater 18 or 24 detected using the temperature sensor (e.g., the sensor unit 13). The controller 12 may control the temperature of the heater 18 or 24 and/or the power supplied to the heater 18 or 24, based on a temperature profile and/or a power profile stored in the memory 17.

According to an embodiment, the controller 12 may control power (e.g., a voltage and/or a current) supplied to the heater 18 or 24 by controlling a power conversion circuit (not shown) electrically connected to the heater 18 or 24 and the power supply 11. For example, the power conversion circuit may include a DC/DC converter (e.g., a buck converter, a buck-boost converter, a boost converter, or a Zener diode) that converts power that is to be supplied to the heater 18 or 24, and a DC/AC converter (e.g., an inverter) that converts power that is to be supplied to an induction coil (not shown). The DC/AC inverter may be implemented as a full-bridge circuit or half-bridge circuit including a plurality of switching elements. For example, the power conversion circuit may include at least one switching element, such as a bipolar junction transistor (BJT) and a field effect transistor (FET).

According to an embodiment, the controller 12 may control the current and/or voltage supplied to the heater 18 or 24 by controlling the frequency and/or duty ratio of a current pulse input to the at least one switching element of the power conversion circuit. A duty ratio with respect to an on/off operation of the switching element may correspond to a ratio of an output voltage of the power conversion circuit to an output voltage of the power supply 11.

According to an embodiment, the controller 12 may control power that is supplied to the heater 18 or 24, by using at least one method among a pulse width modulation (PWM) method and a proportional-integral-differential (PID) method. For example, the controller 12 may control a current pulse having a certain frequency and a duty ratio to be supplied to the heater 18 or 24, by using the PWM method. The controller 12 may control the power supplied to the heater 18 or 24, by adjusting the frequency and duty ratio of the current pulse. For example, the controller 12 may determine a target temperature that is a target of control, based on the temperature profile. The controller 12 may control the power supplied to the heater 18 or 24, by using a PID method, which is a feedback control method using a difference value between the temperatures of the heater 18 or 24 and the target temperature thereof, a value obtained by integrating the difference value according to the flow of time, and a value obtained by differentiating the difference value according to the flow of time.

According to an embodiment, the controller 12 may determine target power that is a target of control, based on the power profile. The controller 12 may control the power supplied to the heater 18 or 24 to correspond to preset target power, according to the flow of time.

According to an embodiment, the controller 12 may detect the user's puff by detecting the power supplied to the heater 18 or 24. In more detail, the controller 12 may control the power supplied to the heater 18 or 24, by using the PID method. When the user' puff occurs, a temporary temperature drop may occur in a space where the aerosol generating article is inserted (hereinafter, the insertion space), the heater 18 or 24, etc. Accordingly, a change may occur in the power (or current) supplied to the heater 18 or 24 during power control using the PID method. The controller 12 may detect the user's puff, based on a change in the power that is controlled.

According to an embodiment, the controller 12 may prevent the heater 18 or 24 from being heated. For example, the controller 12 may control an operation of the power conversion circuit so that the amount of the power supplied to the heater 18 or 24 is reduced or the power supply to the heater 18 or 24 is stopped, based on the temperatures of the heater 18 or 24 exceeding a preset limit temperature.

According to an embodiment, the controller 12 may control charging/discharging of the power supply 11. For example, the controller 12 may check the temperature of the power supply 11 by using the temperature sensor (e.g., the sensor unit 13). When the temperature of the power supply 11 is equal to or greater than a first limit temperature, the controller 12 may block charging of the power supply 11. When the temperature of the power supply 11 is greater than or equal to a second limit temperature, the controller 12 may stop using (e.g., discharging) the power stored in the power supply 11. The controller 12 may calculate the remaining capacity of the power stored in the power supply 11. For example, the controller 12 may calculate the remaining capacity of the power supply 11, based on a voltage and/or current sensing value of the power supply 11.

According to an embodiment, the controller 12 may control supply of power to the heater 18 or 24, based on a result of the sensing performed by the sensor 13.

According to an embodiment, the controller 12 may control supply of power to the heater 18 or 24, based on insertion and/or removal of the aerosol generating article into and/or the insertion space. For example, when it is determined using the insertion detection sensor (e.g., the sensor unit 13) that the aerosol generating article is inserted into the insertion space, the controller 12 may control power to be supplied to the heater 18 or 24. When it is determined using the insertion detection sensor (e.g., the sensor unit 13) that the aerosol generating article has been removed from the insertion space, the controller 12 may block the supply of power to the heater 18 or 24. When the temperature of the heater 18 or 24 are equal to or greater than a limit temperature or a temperature change slope of the heater 18 or 24 is equal to or greater than a set slope, the controller 12 may determine that the aerosol generating article has been removed from the insertion space.

According to an embodiment, the controller 12 may control a power supply time period and/or power supply amount for the heater 18 or 24, based on the state of the aerosol generating article. For example, when it is determined using the overwetting detection sensor (e.g., the sensor unit 13) that the aerosol generating article is in an overwetting state, the controller 12 may increase the power supply time period (e.g., a preheating time period) for the heater 18 or 24.

According to an embodiment, the controller 12 may control supply of power to the heater 18 or 24, based on reuse or non-reuse of the aerosol generating article. For example, when it is determined that the aerosol generating article has been used, the controller 12 may block supply of power to the heater 18 or 24.

According to an embodiment, the controller 12 may control supply of power to the heater 18 or 24, based on attachment and/or removal of the cartridge. For example, when it is determined using the cartridge detection sensor (e.g., the sensor unit 13) that the cartridge is in a separated state, the controller 12 may block supply of power to the heater 18 or 24 or may control power to be not supplied to the heater 18 or 24.

According to an embodiment, the controller 12 may control supply of power to the heater 18 or 24, based on whether the aerosol generating material of the cartridge has been exhausted. For example, when it is determined that the temperature of the heater 18 or 24 exceed the limit temperature while the heater 18 or 24 are being preheated (i.e., in a preheating section), the controller 12 may determine that the aerosol generating material in the cartridge has been exhausted. When it is determined that the aerosol generating material of the cartridge has been exhausted, the controller 12 may cut off the supply of power to the heater 18 or 24.

According to an embodiment, the controller 12 may control the supply of power to the heater 18 or 24, based on whether use of the cartridge is possible. For example, when it is determined based on data stored in the memory 17 that a current number of puffs is equal to or greater than a maximum number of puffs set in the cartridge, the controller 12 may determine that the use of the cartridge is not possible. For example, when a total time period during which the heater 18 or 24 are heated is greater than or equal to a preset maximum time period or a total amount of power supplied to the heater 18 or 24 is greater than or equal to a preset maximum power amount, the controller 12 may determine that the use of the cartridge is not possible. In this case, the controller 12 may block supply of power to the heater 18 or 24 or may control power to be not supplied to the heater 18 or 24.

According to an embodiment, the controller 12 may control the supply of power to the heater 18 or 24, based on the user's puff. For example, the controller 12 may determine occurrence or non-occurrence of a puff and/or the intensity of the puff, by using the puff sensor (e.g., the sensor unit 13). When the number of puffs reaches the preset maximum number of puffs or puffs are not sensed for a preset time period or more, the controller 12 may cut off the supply of power to the heater 18 or 24. When a puff is sensed, the controller 12 may control the supply of power to the heater 18 or 24.

According to an embodiment, the controller 12 may control supply of power to the heater 18 or 24, based on authenticity of the aerosol generating article (or the cartridge) and/or the type of the aerosol generating article. For example, the controller 12 may detect authenticity of the aerosol generating article and/or the type of the aerosol generating article, by using the cigarette identification sensor (e.g., the sensor unit 13). For example, when the aerosol generating article (or the cartridge) is detected as counterfeit, the controller 12 may block supply of power to the heater 18 or 24. When the aerosol generating article (or the cartridge) is detected as authentic, the controller 12 may control (e.g., start) supply of power to the heater 18 or 24. As another example, the controller 12 may differently control power supply to the heater 18 or 24 according to the types of aerosol generating article (or cartridge). In more detail, when the aerosol generating article (or the cartridge) is detected as a first aerosol generating article (or a first cartridge), the controller 12 may control the temperature and/or power of the heater 18 or 24, based on a first temperature profile (or a first power profile), and, when the aerosol generating article (or cartridge) is detected as a second aerosol generating article (or a second cartridge), may control the temperature and/or power of the heater 18 or 24, based on a second temperature profile (or a second power profile).

According to an embodiment, the controller 12 may control the output unit 14, based on a result of the sensing performed by the sensor unit 13. For example, when the number of puffs counted using the puff sensor (e.g., the sensor unit 13) reaches a preset number, the controller 12 may control the output unit 14 to visually, tactually, and/or acoustically provide information indicating that the aerosol generating device 1 is about to be terminated. For example, the controller 12 may control the output unit 14 to visually, tactually, and/or acoustically provide information about the temperature of the heater 18 or 24.

According to an embodiment, the controller 12 may store and update a history of an event occurred in the memory 17, based on certain event occurrence. For example, the event may include insertion detection of the aerosol generating article, heating start of the aerosol generating article, puff detection, puff end, overheat detection of the heater 18 or 24, detection of overvoltage application to the heater 18 or 24, heating end of the aerosol generating article, an operation such as power on/off of the aerosol generation device 1, charging start of the power supply 11, detection of overcharging of the power supply 11, and charging end of the power supply 11, which are performed by the aerosol generating device 1. For example, the history of the event may include, for example, a date and time of the event, and log data corresponding to the event. For example, when a predetermined event is insertion detection of the aerosol generating article, log data corresponding to the event may include data for a sensing value, etc. of the insertion detection sensor (e.g., the sensor unit 13). For example, when the predetermined event is overheating detection of the heater 18 or 24, the log data corresponding to the event may include data about, for example, the temperature of the heater 18 or 24, the voltage applied to the heater 18 or 24, and the current flowing through the heater 18 or 24.

According to an embodiment, the controller 12 may control the communication unit 16 to form a communication link with an external device, such as the user's mobile terminal.

According to an embodiment, when receiving data on authentication from the external device through the communication link, the controller 12 may dismiss limitation of the use of at least one function (e.g., a heating function) of the aerosol generating device 1. For example, the data on authentication may include the user's birthday, a unique number representing the user, and completion or non-completion of authentication of the user.

According to an embodiment, the controller 12 may transmit data on the state of the aerosol generating device 1 (e.g., a remaining capacity of the power supply 11, and an operating mode) to the external device via the communication link. The transmitted data may be output through, for example, a display of the external device.

According to an embodiment, when a request for a location search of the aerosol generating device 1 is received from the external device via the communication link, the controller 12 may control the communication unit 16 to perform an operation corresponding to the location search. For example, the controller 12 may control the haptic unit to generate vibration, or may control the display to output an object corresponding to the location search and a search end.

According to an embodiment, when receiving firmware data from the external device via the communication link, the controller 12 may perform a firmware update.

According to an embodiment, the controller 12 may transmit data on a sensing value of at least one sensor unit 13 to an external server (not shown) through the communication link, and may receive and store a learning model generated by learning sensing values from a server through machine learning, such as deep learning. The controller 12 may perform, for example, an operation of determining the user's inhaling pattern and an operation of generating a temperature profile, by using the learning model received from the server.

Although not shown in FIG. 1, the aerosol generating device 1 may further include a power supply protection circuit. The power protection circuit may include at least one switching element, and may cut off a transmission path to the power supply 11 in response to overcharging and/or overdischarging of the power supply 11. The aerosol generating device 1 may further include a connection interface, such as a universal serial bus (USB) interface, and may transmit/receive information by being connected to another external device through the connection interface, or may charge the power supply 11.

The aerosol generating article as described herein may include at least one aerosol generating rod (e.g., a medium portion) and at least one filter rod. The heater 18 may be arranged to correspond to the at least one aerosol generating rod, and may be designed differently according to arrangement orders and/or locations of the aerosol generating rod and the filter rod. The aerosol generating rod may include at least one of nicotine, an aerosol generating material, and additives. For example, the aerosol generating material may include glycerin (e.g., vegetable glycerin (VG)) and/or propylene glycol (PG), but may also include various other materials. For example, the additives may include flavors and/or organic acid, and may also include various other materials. For example, the aerosol generating rod may include an aerosol generating substrate (e.g., a sheet) impregnated with a liquid non-tobacco material (e.g., an aerosol generating material and/or nicotine), and/or may include a solid tobacco material (e.g., leaf tobacco or reconstituted tobacco. The tobacco material may be included in the aerosol generating rod in various forms, such as cut tobacco, granules, or powder. According to an embodiment, the additives of the aerosol generating rod may include an alkaline material. Based on the alkaline material, the nicotine of the tobacco material included in the aerosol generating rod may have an alkaline pH (e.g., greater than pH 7.0). In this case, freebase nicotine may be released from the aerosol generating rod even at low temperature. According to an embodiment, the aerosol generating rod may include two or more aerosol generating rods, wherein the two or more aerosol generating rods may include a tobacco material and/or a non-tobacco material, respectively. Although not shown, at least one aerosol generating rod and at least one filter rod may be individually and/or integrally wrapped by at least one wrapper. In the disclosure, the aerosol generating article may be referred to as a stick.

The cartridge mentioned in the disclosure may contain an aerosol generating material in any one state among a liquid state, a solid state, a gaseous state, a gel state, and the like. The aerosol generating material may include a liquid composition. For example, the liquid composition may be a liquid including a tobacco-containing material having a volatile tobacco flavor component, or may be a liquid including a non-tobacco material. The cartridge may include a storage containing an aerosol generating material and/or a liquid delivery unit impregnated with (containing) the aerosol-generating material. For example, the liquid delivery unit may include a wick or the like, such as a cotton fiber, a ceramic fiber, a glass fiber, or porous ceramic. The cartridge heater 24 may be included in the cartridge, as a coil-shaped structure that is wound around the liquid delivery unit or in a structure in contact with one side of the liquid delivery unit. Alternatively, the cartridge heater 24 may be included in an aerosol generating device 1 that is separable from the cartridge.

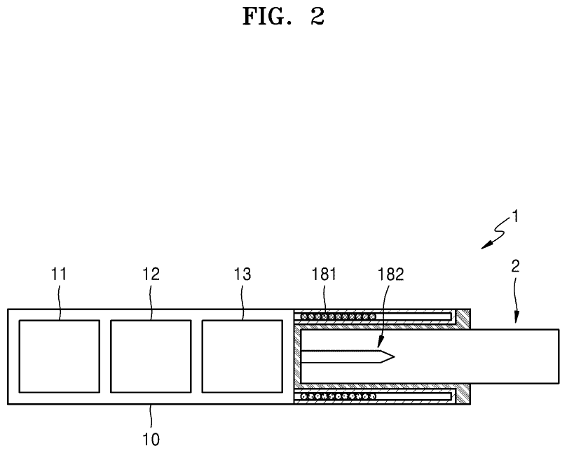

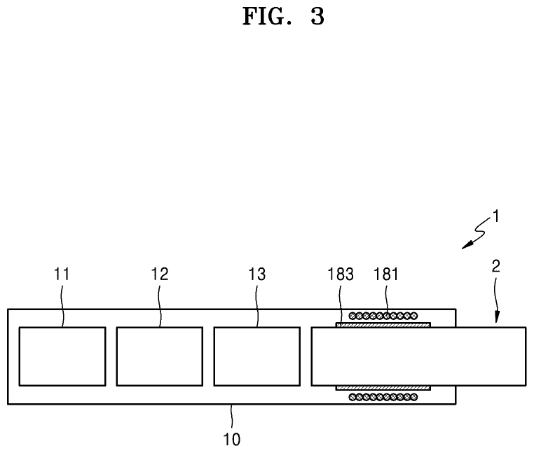

FIG. 2 illustrates an aerosol generating device 1 according to an embodiment. FIG. 3 illustrates an aerosol generating device 1 according to an embodiment.

According to an embodiment, the aerosol generating device 1 may include a housing 10, the power supply 11, the controller 12, the sensor unit 13, and/or a heater 182 or 183 (e.g., the heater 18 of FIG. 1). However, the components included in the aerosol generating device 1 are not limited to those shown in FIG. 2 or 3. It may be understood by those skilled in the art that some of the components shown in FIG. 2 or 3 may be omitted or new components may be added. The aerosol generating device 1 illustrated in FIG. 2 may be referred to as an ‘internal heating type’ aerosol generating device that heats the inside of an aerosol generating article 2. The aerosol generating device 1 illustrated in FIG. 3 may be referred to as an ‘external heating type’ aerosol generating device that heats the outside of the aerosol generating article 2. In the drawings below, any description that overlaps with FIG. 1 will be omitted.

According to an embodiment, the housing 10 may provide a space opened upward so that the aerosol generating article 2 may be inserted. In the disclosure, the upwardly-opened space may be referred to as an insertion space. The insertion space may be recessed toward the inside of the body 10 by a certain depth so that at least a portion of the aerosol generating article 2 may be inserted thereinto. The depth of the insertion space may be equal to or greater than a length of a region in the aerosol generating article 2, in which an aerosol generating material and/or a medium is included. A lower end of the aerosol generating article 2 may be inserted into the housing 10, and an upper end of the aerosol generating article 2 may protrude to the outside of the housing 10. A user may inhale aerosol by holding, in his or her mouth, the upper end of the aerosol generating article 2 exposed to the outside.

According to an embodiment, the heaters 182 and 183 may heat the aerosol generating article 2.

Referring to FIG. 2, the heater 182 may be implemented as an internal heating heater.

According to an embodiment, the internal heating heater may extend long upward in a space (i.e., the insertion space) into which the aerosol generating article 2 is inserted. As illustrated in FIG. 2, the internal heating heater may include a rod-shaped heating element or a needle-shaped heating element. However, the internal heating heater may include any of various heating elements, such as a tube-shaped heating element or a plate-shaped heating element. The internal heating heater may be inserted through a lower side of the aerosol generating article 2.

According to an embodiment, the internal heating heater may include an electrically resistive heater and/or an induction heating heater.

For example, the electrically resistive heater may include an electrically resistive material on the inside (e.g., an inner hollow or an inner surface) or the outside (e.g., an outer surface), and may be heated as a current flows through the electrically resistive material. In this case, the electrically resistive heater may be electrically connected to the power supply 11, and may directly generate heat by receiving a current from the power supply 11. An induction coil 181 may be omitted.

For example, in the case of induction heating heaters, the aerosol generating device 1 may include the induction coil 181 surrounding at least a portion of the internal heating heater (e.g., being positioned outside to correspond to a length of at least a portion of the heater). In this case, a magnetic flux concentrator, etc. may be further included on the outside of the induction coil 181 in order to increase the efficiency of induction heating. An induction heating heater may include a susceptor, and may generate heat based on a magnetic field generated by the induction coil 181. According to an embodiment, the induction heating heater (e.g., a susceptor) (or a heater module including the induction heating heater) may be arranged to be detachable from the housing 10.

According to an embodiment, the heater 181 may be multiple heaters. The multiple heaters may include a first heater and a second heater, and may be inserted into the aerosol generating article 2. The first heater and the second heater may be arranged in parallel to each other in a longitudinal direction. The first heater and the second heater may operate as electrically resistive heaters and/or induction heating heaters, and may be sequentially heated or may be simultaneously heated. In this case, the first heater and the second heater may be respectively arranged at locations corresponding to longitudinal locations of two or more aerosol generating rods. Alternatively, the first heater and the second heater may be respectively arranged at locations corresponding to longitudinal locations of a first portion and a second portion of one aerosol generating rod. When the heater 182 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 182. Three or more heaters and/or three or more induction coils may be included.

According to an embodiment, a susceptor may be disposed (or included) in the inside (e.g., the medium portion) of the aerosol generating article 2, and the susceptor included within the aerosol generating article 2 may be implemented to generate heat, based on the magnetic field generated by the induction coil 181.

Referring to FIG. 3, the heater 183 may be an external heating heater.

According to an embodiment, the external heating heater may extend long upward around a space (i.e., the insertion space) into which the aerosol generating article 2 is inserted. For example, the external heating heater may be disposed to surround at least a portion of the insertion space. For example, the external heating heater may include a tubular shape (e.g., a cylindrical shape) including a hollow therein. The external heating heater may have a shape including a hollow on the inside and surrounding the hollow. In this case, the external heating heater may be supported by a polyimide film. A heater supported by such a film may be referred to as a film heater. The external heating heater may be disposed to surround at least a portion of the insertion space. The external heating heater may heat the outside of the aerosol generating article 2 inserted into the hollow.

According to an embodiment, the external heating heater may include an electrically resistive heater and/or an induction heating heater. A description of FIG. 3 that overlaps with FIG. 2 will be omitted. In the case of induction heating heaters, the aerosol generating device 1 may include an external heating heater implemented as a tube-shaped susceptor, and may include the induction coil 181 surrounding at least a portion of the external heating heater (e.g., being positioned outside to correspond to a length of at least a portion of the heater). The induction coil 181 may include a fan coil. When the external heating heater is an electrically resistive heater, heat generation is possible through a current flow on a tube-shaped electrically resistive heater (e.g., a film heater), and thus the separate induction coil 181 may be omitted. Insulation may also be disposed on the outside of the external heating heater. Accordingly, the heat radiated outward by the heater 183 and applied to the outside of the housing 10 may be reduced.

According to one embodiment, the heater 183 may be multiple heaters, and the first heater and the second heater may be arranged side by side along the longitudinal direction so as to each surround at least a portion of the insertion space. The first heater and the second heater may operate as electrically resistive heaters and/or induction heating heaters, and may be sequentially heated or may be simultaneously heated. When the heater 183 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 183.

Unlike what is shown in FIG. 2 or FIG. 3, the heater 182 of FIG. 2 and the heater 183 of FIG. 3 may be included together in the aerosol generating device 1. In this case, the heater 182 may heat the inside of the aerosol generating article 2, and the heater 183 may heat the outside of the aerosol generating article 2.

According to an embodiment, the aerosol generating device 1 may be provided with an airflow channel through which air flows. For example, the housing 10 may include a structure (e.g., a hole) in which air may be introduced from the outside into the housing 10. The air introduced into the housing 10 may be introduced into the aerosol generating article 2 through the lower end (i.e., an upstream side) of the aerosol generating article 2. Aerosol generated based on the heating of the aerosol generating article 2, together with the introduced air, may be inhaled into the user's mouth through the upper end (i.e., the downstream side) of the aerosol generating article 2.

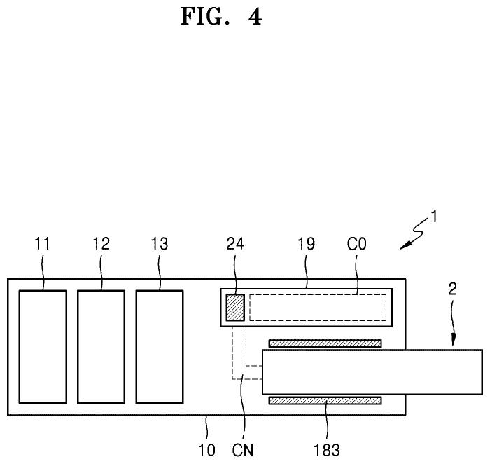

FIG. 4 illustrates the aerosol generating device 1 according to an embodiment.

According to an embodiment, the aerosol generating device 1 may include the housing 10, the power supply 11, the controller 12, the sensor unit 13, and/or the heaters 183 and 24 (e.g., the heater 18 or 24 of FIG. 1). However, the components included in the aerosol generating device 1 are not limited to those shown in FIG. 4. It may be understood by those skilled in the art that some of the components shown in FIG. 4 may be omitted or new components may be added. In the drawings below, any description that overlaps with FIG. 1 will be omitted.

According to an embodiment, the housing 10 may provide a space (hereinafter, an insertion space) opened upward so that the aerosol generating article 2 may be inserted. The insertion space may be recessed toward the inside of the body 10 by a certain depth so that at least a portion of the aerosol generating article 2 may be inserted thereinto. The lower end of the aerosol generating article 2 may be inserted into the housing 10, and the upper end of the aerosol generating article 2 may protrude to the outside of the housing 10.

Unlike the illustration, the cartridge 19 may provide an insertion space for accommodating the aerosol generating article 2. In this case, the insertion space may be recessed toward the inside of the cartridge 19 by a certain depth so that at least a portion of the aerosol generating article 2 may be inserted thereinto. The lower end of the aerosol generating article 2 may be inserted into the cartridge 19, and the upper end of the aerosol generating article 2 may protrude to the outside of the cartridge 19. In this case, the aerosol generating device 1 may not include the heater 183.

According to an embodiment, the depth of the insertion space may be equal to or greater than a length of a region in the aerosol generating article 2, in which an aerosol generating material and/or a medium is included. A user may inhale aerosol by holding, in his or her mouth, the upper end of the aerosol generating article 2 exposed to the outside.

According to an embodiment, the heater 183 may heat the aerosol generating article 2. The heater 183 may extend long upward around the space (i.e., the insertion space) into which the aerosol generating article 2 is inserted. For example, the heater 183 may have a tubular shape (e.g., a cylindrical shape) including a hollow therein. The heater 183 may have a shape including a hollow on the inside and surrounding the hollow. In this case, the heater 183 may be supported by a polyimide film. A heater supported by such a film may be referred to as a film heater. The heater 183 may be arranged to surround at least a portion of the insertion space. The heater 183 may heat the outside of the aerosol generating article 2 inserted into the hollow. In the disclosure, the heater 183 may be referred to as an external heating heater that heats the outside of the aerosol generating article 2. Insulation may also be disposed on the outside of the heater 183. Accordingly, the heat radiated outward by the heater 183 and applied to the outside of the housing 10 may be reduced.

According to an embodiment, the heater 183 may include an electrically resistive heater and/or an induction heating heater.

For example, the electrically resistive heater may include an electrically resistive material, and may be heated as a current flows through the electrically resistive material. In this case, the electrically resistive heater may be electrically connected to the power supply 11, and may generate heat directly by receiving a current from the power supply 11.

For example, in the case of induction heating heaters, the aerosol generating device 1 may include an induction coil (not shown) surrounding at least a portion of the heater 183 (e.g., being disposed outside to correspond to a length of at least a portion of the heater 183). In this case, a magnetic flux concentrator, etc. may be further included on the outside of the induction coil (not shown) in order to increase the efficiency of induction heating. An induction heating heater may include a susceptor, and may generate heat based on a magnetic field generated by the induction coil (not shown).

According to an embodiment, the heater 183 may be multiple heaters. The multiple heaters may include a first heater and a second heater, and may be inserted into the aerosol generating article 2. The first heater and the second heater may be arranged in parallel to each other in a longitudinal direction. The first heater and the second heater may operate as electrically resistive heaters and/or induction heating heaters, and may be sequentially heated or may be simultaneously heated. In this case, the first heater and the second heater may be respectively arranged at locations corresponding to longitudinal locations of two or more aerosol generating rods. Alternatively, the first heater and the second heater may be respectively arranged at locations corresponding to longitudinal locations of a first portion and a second portion of one aerosol generating rod. When the heater 183 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 183. Three or more heaters and/or three or more induction coils may be included.

Unlike what is illustrated, the aerosol generating device 1 may not include the heater 183. The aerosol generating article 2 may be heated directly or indirectly by the cartridge heater 24, or may not be substantially heated. The indirect heating may mean that the aerosol generating article 2 is heated by receiving heat contained in the aerosol, while the aerosol generated by the cartridge heater 24 is passing through the aerosol generating article 2. In this case, the aerosol generating device 1 may be referred to as a non-heating (or indirect heating) aerosol generating device. The aerosol generating rod of the aerosol generating article 2 may contain additives such as a alkaline material. Based on the alkaline material, nicotine included in the aerosol generating rod may have an alkaline pH (e.g., pH of greater than 7.0). This alkaline nicotine may flow into the user's mouth, together with the aerosol flowing from the cartridge 19, which will be described later, into the aerosol generating article 2.

Unlike the illustration, the heater 183 may include an internal heating heater. For example, the internal heating heater may include any of various heating elements, such as a rod-shaped heating element, a tube-shaped heating element, a plate-shaped heating element, or a needle-shaped heating element. The internal heating heater may be inserted through a lower side of the aerosol generating article 2, and may be set to heat the inside of the aerosol generating article 2.

According to an embodiment, the cartridge 19 may be detachably coupled to the housing 10. For example, a space may be formed on one side of the housing 10, and at least a portion of the cartridge 19 may be inserted into the space formed on one side of the body 10, so that the cartridge 19 may be mounted in the housing 10. Alternatively, the cartridge 19 may be integrally formed with the housing 10.

According to an embodiment, the aerosol generating device 1 and/or the cartridge 19 may be provided with an airflow channel through which air flows. For example, the housing 10 may include a structure in which air may be introduced from the outside into the housing 10 while the cartridge 19 is being inserted into the housing 10. The introduced air may pass through the cartridge 19 and be introduced into the insertion space through an airflow channel CN, and may flow into the user's mouth. The airflow channel CN may include various structures for reducing residual droplets or facilitate airflow.

In FIG. 4, the cartridge 19 is shown as being positioned on a lateral side with respect to the aerosol generating article 2, and the airflow channel CN is shown as being formed from a lateral surface of the aerosol generating article 2 to the lower end (i.e., the upstream side) of the aerosol generating article 2. However, the locations of the cartridge 19 and the airflow channel CN are not limited thereto. For example, the cartridge 19 may be located adjacent to the lower end (i.e., the upstream side) of the aerosol generating article 2. In this case, the airflow channel CN may be formed in a substantially straight shape to connect the cartridge 19 to the lower end (i.e., the upstream side) of the aerosol generating article 2.

According to an embodiment, the cartridge 19 may include a storage CO containing an aerosol generating material, the cartridge heater 24, and/or a liquid delivery unit impregnated with (containing) the aerosol generating material. The liquid delivery unit may be impregnated with the aerosol generating material supplied by the storage CO. For example, the liquid delivery unit may include a wick or the like, such as a cotton fiber, a ceramic fiber, a glass fiber, or porous ceramic.

According to an embodiment, the cartridge heater 24 may heat the aerosol generating material included in the cartridge 19. For example, the cartridge heater 24 may include an electrically resistive heater and/or an induction heating heater.

For example, the electrically resistive heater may include an electrically resistive material, and may generate heat as a current flows through the electrically resistive material. As another example, in the case of induction heating heaters, the aerosol generating device 1 may further include an induction coil (not shown) around the induction heating heater. The induction heating heater may include a susceptor, and may generate heat based on a magnetic field generated by the induction coil (not shown). The cartridge heater 24 may be formed in the shape of a coil that surrounds (or is wound around) the liquid delivery unit and/or in a shape (e.g., a pattern shape) in contact with one side of the liquid delivery unit.

Unlike the illustration, the cartridge heater 24 may be included in the aerosol generating device 1. For example, the cartridge heater 24 may be included inside the housing 10. In this case, the cartridge 19 and the cartridge heater 24 may be separated from each other by removing the cartridge 19.

According to an embodiment, aerosol may be generated based on the heat generation of the cartridge heater 24. For example, as the aerosol generating material impregnated in the liquid delivery unit is heated by the cartridge heater 24, vapor may be generated from the aerosol generating material, and, as the generated vapor is mixed with outside air introduced into the cartridge 19, aerosol may be generated. The aerosol generated by the cartridge heater 24 may be introduced into the aerosol generating article 2 through the airflow channel CN. Tobacco or a flavoring agent may be added to the aerosol while the aerosol is passing through the aerosol generating article 2, and the aerosol to which tobacco or a flavoring agent has been added may be inhaled into the user's mouth through one end of the aerosol generating article 2.

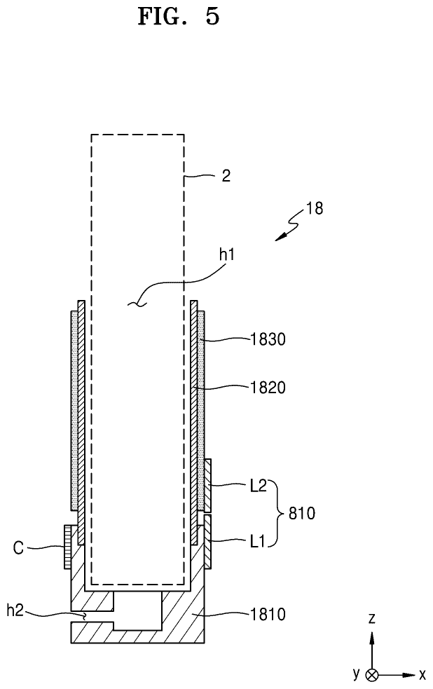

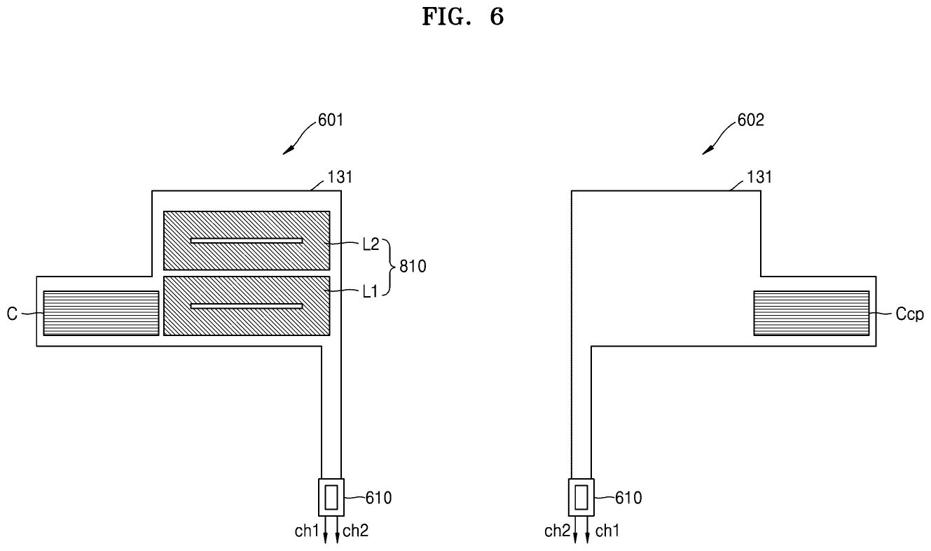

FIG. 5 is a cross-sectional view of a heater assembly for explaining an arrangement of an inductor and a capacitor according to an embodiment, and FIG. 6 is a drawing for explaining an inductor and a capacitor formed integrally with each other.

In FIG. 5, the heater 18 is illustrated as an external heating heater that heats the outside of the aerosol generating article 2. In FIG. 5, the heater 18 is also illustrated as an electrically resistive heater. However, the heater 18 according to the disclosure is not limited thereto, and, when the aerosol generating device 1 includes a cavity h1 that accommodates an aerosol generating substrate, and inductors L1 and L2 (hereinafter, referred to as L when there is no need for distinction) and a capacitor C surround the cavity h1, the heater 18 according to the disclosure is not limited to the example of FIG. 5. That is, the structures and heating methods described above with reference to FIGS. 2 through 4 may also be applied to a following description of the heater 18.

Referring to FIG. 5, the heater 18 may be disposed within the housing 10. The heater 18 may be referred to as a heater assembly. The heater 18 may have a tubular shape or cylindrical shape including a hollow therein. The heater 18 may surround the cavity h1. The cavity h1 may be referred to as an insertion space and may be provided by the heater 18. The cavity h1 or the aerosol generating article 2 inserted into the cavity h1 may be heated by the heater 18.

The heater 18 may include a flange 1810, a thermally conductive member 1820, and an electrically conductive track 1830. According to an embodiment, the heater 18 may further include an insulator (not shown) between the thermally conductive member 1820 and the electrically conductive track 1830 or on the outside of the thermally conductive member 1820. The insulator may be formed of a material that is flexible and heat resistant. The insulator may include, but is not limited to, polyimide or polyetheretherketone (PEEK), and may include other materials having elasticity, heat resistance, and electrical insulation properties.

The flange 1810 may be coupled to the housing 10. The thermally conductive member 1820 may be attached or press-fitted to the flange 1810. The cavity h1 may be formed by coupling the flange 1810 to the thermally conductive member 1820. The thermally conductive member 1820 may be located on an innermost side of the heater 18. The thermally conductive member 1820 may be coupled to the flange 1810 and may extend in a vertical direction of the aerosol generating device 1. The thermally conductive member 1820 may be disposed on an inner side of the electrically conductive track 1830, and may surround at least a portion of the cavity h1. At least a portion of an inner circumferential surface of the thermally conductive member 1820 may be in contact with an outer circumferential surface of the aerosol generating article 2 inserted into the cavity h1. The thermally conductive member 1820 may be manufactured of, but is not limited to, stainless steel, aluminum, or an alloy.

The electrically conductive track 1830 may have a cylindrical shape. The electrically conductive track 1830 may be disposed on the outside of the thermally conductive member 1820. The electrically conductive track 1830 may surround at least a portion of the thermally conductive member 1820. The electrically conductive track 1830 may receive power from the power supply 11 to generate heat. The electrically conductive track 1830 may be formed by etching a metal thin film with a laser. The electrically conductive track 1830 may be manufactured of, but is not limited to, stainless steel, copper, aluminum, or an alloy.

The flange 1810 may include an aperture h2. The aperture h2 may be formed on one side of the flange 1810 and may communicate with the cavity h1. The aerosol generating article 2 may be inserted into the cavity h1. External air may be introduced through the aperture h2, and may be introduced into the inside of the aerosol generating article 2 via an end of the aerosol generating article 2.

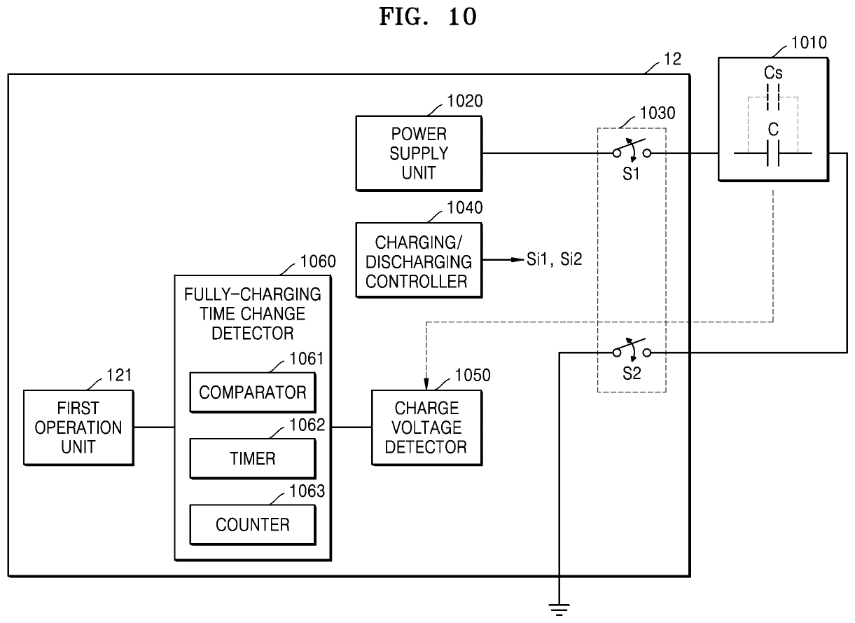

An inductor unit 810 and a capacitor unit 1010 (see FIG. 10) may be arranged in the heater 18 in order to detect whether the aerosol generating article 2 is inserted. The inductor unit 810 may include at least one inductor L. The capacitor unit 1010, which is at least one capacitive sensor, may include the capacitor C. In FIG. 5, the inductor unit 810 is illustrated as including the first inductor L1 and the second inductor L2, and the capacitor unit 1010 is illustrated as including one capacitor C. However, the number of inductors L and the number of capacitors C are not limited thereto.

The first inductor L1 and the second inductor L2 may surround at least a portion of the cavity h1. The capacitor C may surround a remaining portion of the cavity h1. An area where the first inductor L1 and the second inductor L2 surround the cavity h1 and an area where the capacitor C surrounds the cavity h1 may not overlap each other. The first inductor L1, the second inductor L2, and the capacitor C may be integrally formed with each other and surround the cavity h1.

FIG. 6 illustrates the inductor unit 810 and the capacitor unit 1010 arranged on a first surface 601 and a second surface 602 of an insulating substrate 131. In FIG. 6, the first surface 601 may refer to a surface facing the cavity h1, and the second surface 602 may refer to a surface opposite to the first surface 601. Referring to FIG. 6, the inductor unit 810 may include the first inductor L1 and the second inductor L2, and the first inductor L1 and the second inductor L2 may be implemented on the first surface 601 of the insulating substrate 131 in a pattern shape. In this case, the insulating substrate 131 may be, but is not limited to, a flexible printed circuit board (FPCB). The first inductor L1 and the second inductor L2 may be arranged side by side in a vertical direction. The first inductor L1 may be disposed on a lower side of the insulating substrate 131, and the second inductor L2 may be spaced apart from the first inductor L1 to be disposed above the first inductor L1.

The first inductor L1 and the second inductor L2 included in the inductor unit 810 are passive elements, and inductance of the first inductor L1 and the second inductor L2 may vary as the aerosol generating article 2 is accommodated in the cavity h1. The controller 12 may monitor a variable value of the inductance through a first channel ch1 of a signal transmitter 610. As such, because the inductor unit 810 includes only a passive element with variable inductance, the inductor unit 810 may be referred to as an inductor antenna. The capacitor unit 1010 may include the capacitor C and may be implemented on the first surface 601 of the insulating substrate 131 in a pattern shape. The capacitor C may be spaced apart from the first inductor L1 and disposed side by side with the first inductor L1 in left and right directions.

The capacitor C may be provided in the form of a single electrode. Because the single electrode surrounds the cavity h1, the cavity h1 may be understood as a dielectric space that causes a change in the capacitance. In other words, when the aerosol generating article 2 is inserted into the cavity h1, a permittivity of a single electrode, which is a passive element, may vary, and accordingly, the capacitance may also vary. As such, the capacitor unit 1010 may output the capacitance of the single electrode without separately including a transmission electrode and a reception electrode. The controller 12 may monitor a variable value of the capacitance through a second channel ch2 of the signal transmitter 610. Because the capacitor unit 1010 includes only a passive element with variable capacitance, the capacitor unit 1010 may be referred to as a capacitor antenna.

According to an embodiment, the capacitor unit 1010 may include a plurality of electrodes. In this case, the capacitor unit 1010 may further include a compensation capacitor Ccp disposed on the second surface 602 of the insulating substrate 131. The compensation capacitor Ccp may be disposed at a location corresponding to the capacitor C on the second surface 602 of the insulating substrate 131. Because the capacitor C disposed on the first surface 601 is disposed close to a heating space, the capacitor C may not exhibit an expected charging/discharging effect according to an increase in the temperature of the heating space, or may be fractured according to an increase in the temperature of the heating space. The compensation capacitor Ccp may be disposed on the second side 602 of the insulating substrate 131 in order to achieve temperature or fracture compensation of the capacitor C. An output value of the compensation capacitor Cop may be transmitted to the controller 12 through the second channel ch2 of the signal transmitter 610 together with an output value of the capacitor C, or may be transmitted to the controller 12 through a separate channel (not shown). According to embodiments, the inductor unit 810 may also further include additional inductors (not shown) arranged on the second surface 602 of the insulating substrate 131 in addition to the first and second inductors L1 and L2 arranged on the first surface 601 of the insulating substrate 131. The additional inductors arranged on the second surface 602 may also be arranged to compensate for temperature or fracture of the first and second inductors L1 and L2 arranged on the first surface 601 or to detect changes in external inductance of the cavity h1. The aerosol generating device 1 according to the disclosure includes the inductor unit 810 and the capacitor unit 1010 formed integrally as a thin film sharing the signal transmitter 610, leading to a significant reduction in apparatus size. Moreover, unlike inductive sensors and capacitive sensors provided in the form of conventional IC chips, the aerosol generating device 1 according to the disclosure is provided with only passive elements that are distinguished from the controller 12, and the controller 12 includes components for determining the amount of change in a monitoring value within an IC chip. Therefore, power consumption is significantly reduced compared to conventional IC chip-type sensors, and product miniaturization may be enabled.

Referring back to FIG. 5, the first inductor L1 and the second inductor L2 may surround at least a portion of the cavity h1 formed by the flange 1810 and the thermally conductive member 1820. For convenience of explanation, in FIG. 5, the insulating substrate 131 is omitted. The first inductor L1 may surround at least a portion of the cavity h1, at a lower side of the heater 18. The first inductor L1 may be disposed to contact a portion of the flange 1810 and surround a portion of an outer side of the heater 1810. The second inductor L2 may be disposed adjacent to an upper side of the first inductor L1, and may surround at least a portion of the cavity h1. The second inductor L2 may be disposed apart from the first inductor L1, and may contact a portion of the thermally conductive member 1820. The second inductor L2 may be disposed to surround a portion of an outer side of the thermally conductive member 1820.

The capacitor C may surround a remaining portion of the cavity h1 formed by the thermally conductive member 1820. The capacitor C may be disposed to contact a portion of the flange 1810 and surround a portion of the outer side of the heater 1810. The capacitor C may surround at least a portion of the cavity h1 at the lower side of the heater 18, but a cover area of the capacitor C and a cover area of the first inductor L1 may not overlap each other. Accordingly, as in FIG. 5, a portion of the capacitor C may be disposed to face a portion of the first inductor L1.

The controller 12 may monitor an amount of change in inductance of each of the first inductor L1 and the second inductor L2. The amount of change in inductance of at least one of the first inductor L1 and the second inductor L2 may be calculated as a first monitoring value by the controller 12.

The controller 12 may also monitor an amount of change in capacitance of the capacitor C. The amount of change in capacitance of the capacitor C may be calculated as a second monitoring value by the controller 12.

The controller 12 may determine whether the aerosol generating article 2 is accommodated in the cavity h1, based on at least one of the first monitoring value and the second monitoring value. Because components for detecting insertion or non-insertion of the aerosol generating article 2 are arranged on a lower end of the cavity h1, the aerosol generating device 1 according to the disclosure may significantly reduce a malfunction of the heater 18. In other words, the aerosol generating device 1 according to the disclosure automatically heats the heater 18 only when the aerosol generating article 2 is completely inserted into the cavity h1, thereby preventing unnecessary heating of the heater 1.

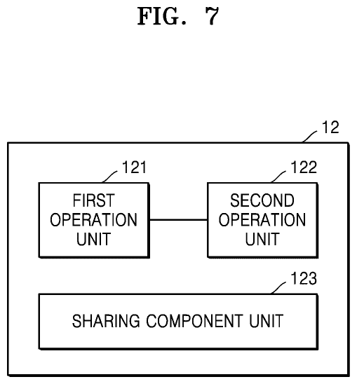

FIG. 7 is a block diagram of an internal structure of the controller 12 according to an embodiment.

Referring to FIG. 7, the controller 12 may include a first operation unit 121, a second operation unit 122, and a sharing component unit 123. The first operation unit 121 and the second operation unit 122 may be referred to as a central processing unit (CPU) or a central processing unit core because they are components where actual data processing is performed. The sharing component unit 123 may also be referred to as peripherals because they are a set of auxiliary components for data processing.

The first operation unit 121 may determine insertion or non-insertion of the aerosol generating article 2. The first operation unit 121 may obtain the first monitoring value corresponding to a change in the inductance of the inductor unit 810 and the second monitoring value corresponding to a change in the capacitance of the capacitor unit 1010. The first operation unit 121 may also determine whether the aerosol generating article 2 is inserted into the cavity h1, based on at least one of the first monitoring value and the second monitoring value.

The first operation unit 121 may use some of the components included in the sharing component unit 123, in order to obtain the first monitoring value and the second monitoring value. Some of the components included in the sharing component unit 123 may be electrically connected to the first operation unit 121 and may function to derive the first monitoring value and the second monitoring value.

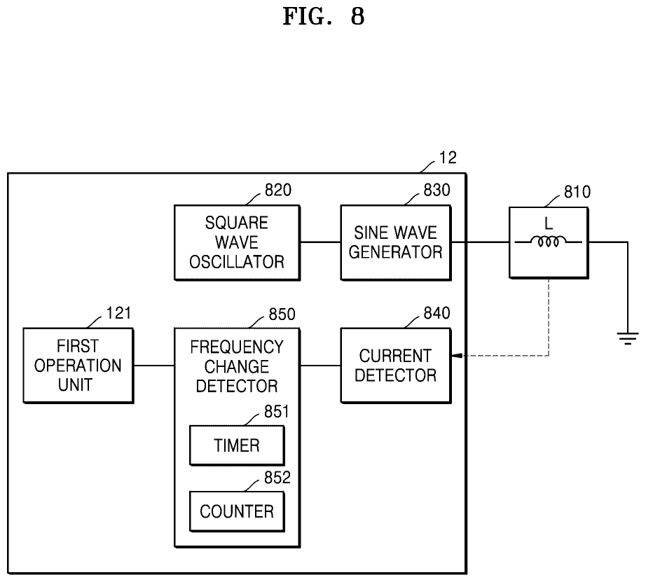

The sharing component unit 123 may include components for determining a change in the inductance of the inductor unit 810 and a change in the capacitance of the capacitor unit 1010. In order to obtain the first monitoring value, the sharing component unit 123 may include a square wave oscillator 820 of FIG. 8, a sine wave generator 830 of FIG. 8, a current detector 840 of FIG. 8, a frequency change detector 850 of FIG. 8, a timer 851 of FIG. 8, and a counter 852 of FIG. 8. In order to obtain the second monitoring value, the sharing component unit 123 may further include a power supply unit 1020 of FIG. 10, a switching unit 1030 of FIG. 10, a charging/discharging controller 1040 of FIG. 10, a charge voltage detector 1050 of FIG. 10, a full-charge time change detector 1060 of FIG. 10, a comparator 1061 of FIG. 10, a timer 1062 of FIG. 10, and a counter 1063 of FIG. 10.

The first operation unit 121 may obtain a frequency change of the inductor unit 810 as the first monitoring value by using some of the components included in the sharing component unit 123. The first operation unit 121 may obtain a charging time change of the inductor unit 1010 as the second monitoring value by using some of the components included in the sharing component unit 123. The first operation unit 121 may determine whether the aerosol generating article 2 is inserted into the cavity h1, based on at least one of the first monitoring value and the second monitoring value. According to an embodiment, the first monitoring value may be set as a main parameter for determining insertion or non-insertion of the aerosol generating article 2, and the second monitoring value may be set as an auxiliary parameter for determining insertion or non-insertion of the aerosol generating article 2. In other words, when the first monitoring value deviates from a first reference range and the second monitoring value deviates from a second reference range, the first operation unit 121 may determine whether the aerosol generating article 2 is inserted into the cavity h1. Because the aerosol generating device 1 according to the disclosure determines insertion or non-insertion of the aerosol generating article 2 by considering not only a change in the inductance but also a change in the capacitance, the aerosol generating device 1 may obtain a more accurate result.

According to an embodiment, the first operation unit 121 may obtain amounts of change in a plurality of inductances, as the first monitoring value. For example, in an embodiment in which the inductor unit 810 includes a plurality of inductors, namely, the first and second L1 and L2, as shown in FIGS. 5 and 6, the first operation unit 121 may obtain, as a first change value, an inductance change value of the first inductor L1 surrounding the lower side of the cavity h1. The first operation unit 121 may obtain, as a second change value, an inductance change value of the second inductor L2 disposed above the first inductor L1. When both the first change value and the second change value deviate from the first reference range, the first operation unit 121 may additionally obtain the second monitoring value to finally determine insertion or non-insertion of the aerosol generating article 2. Because the aerosol generating device 1 according to the disclosure obtains the first monitoring value, which is a main parameter, from a plurality of change values, the accuracy of determining insertion or non-insertion is more improved.

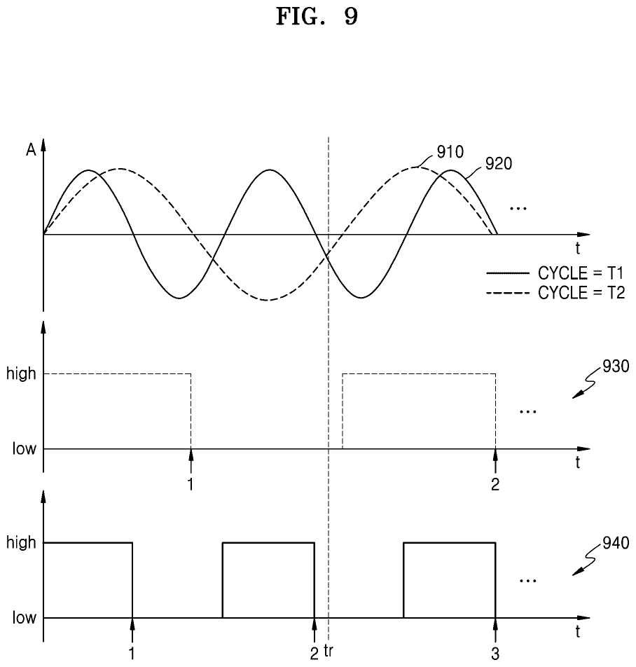

A method, performed by the first operation unit 121, of obtaining the first monitoring value will be described in more detail with reference to FIGS. 8 and 9, and a method, performed by the first operation unit 121, of obtaining the second monitoring value will be described in more detail with reference to FIGS. 10 through 14.

The first operation unit 121 may be provided with constant power. Alternatively, the first operation unit 121 may be provided with power at preset intervals. The second operation unit 122 may operate in a sleep mode in which minimum power is consumed or power is cut off until a wake-up signal to be described later is received.

When the first operation unit 121 determines that the aerosol generating article 2 is inserted into the cavity h1, the first operation unit 121 may transmit the wake-up signal to the second operation unit 122. When the second operation unit 122 receives the wake-up signal, the second operation unit 122 may be woken up and may control an operation of the aerosol generating device 1.

The first operation unit 121 may be provided to perform a first function, and the second operation unit 122 may be provided to perform a second function that is different from the first function. According to an embodiment, the first function may refer to a function of determining insertion or non-insertion of the aerosol generating article 2, and the second function may refer to various functions that may be performed by the aerosol generating article 2 other than the function of determining insertion or non-insertion of the aerosol generating article 2. For example, the second operation unit 122 may control the output unit 14 to output a status of the aerosol generating device 1. Alternatively, the second operation unit 122 may communicate with an external device by controlling the communication unit 16. Alternatively, the second operation unit 122 may control the heater 18 to heat the aerosol generating article 2 accommodated in the cavity h1.

Sharing of the sharing component unit 123 may refer to sharing between the first operation unit 121 and the second operation unit 122 as well as sharing of the components for determining a change in the inductance and a change in the capacitance. In other words, the components included in the sharing component unit 123 may also be used to perform the function of the second operation unit 122.

Performance of the first operation unit 121 may be lower than performance of the second operation unit 122. A clock speed of the first operation unit 121 may be less than a clock speed of the second operation unit 122. For example, the clock speed of the first operation unit 121 may be selected in the range of 30 MHz to 90 MHZ, and the clock speed of the second operation unit 122 may be selected in the range of 90 MHz to 210 MHz. The number of interrupt processes of the first operation unit 121 may be less than the number of interrupt processes of the second operation unit 122. For example, the number of interrupt processes of the first operation unit 121 may be 10 to 50, and the number of interrupt processes of the second operation unit 122 may be 220 to 260. Power consumption of the first operation unit 121 may be less than power consumption of the second operation unit 122. For example, the power consumption of the first operation unit 121 may be 4 uW/MHz to 13 uW/MHZ, and the power consumption of the second operation unit 122 may be 20 uW/MHz to 40 uW/MHz. However, the difference between the performance of the first operation unit 121 and the performance of the second operation unit 122 is only an example, and the clock speed, the number of interrupts processing, and the power consumption are not limited thereto.

FIG. 8 is a drawing for explaining a method of obtaining a first monitoring value corresponding to a change in inductance, according to an embodiment, and FIG. 9 illustrates graphs for explaining a method of determining the frequency change of FIG. 8.

Referring to FIG. 8, the controller 12 may include the square wave oscillator 820, the sine wave generator 830, the current detector 840, the frequency change detector 850, and the first operation unit 121. The square wave oscillator 820, the sine wave generator 830, the current detector 840, and the frequency change detector 850 may be the components included in the sharing component unit 123. In FIG. 8, the controller 12 is illustrated as mainly including components that perform operations related to obtainment of the first monitoring value. However, the controller 12 may be equipped with other components in addition to the components described above with reference to FIG. 8.

The square wave oscillator 820 may include general-purpose input/output (GPIO) pins, and any one of the GPIO pins may be set as an output port. The square wave oscillator 820 may output a square wave having a preset period through the output port, based on an interrupt signal.

The sine wave generator 830 may generate AC power having a sine wave, based on the square wave output by the square wave oscillator 820. The AC power output by the sine wave generator 830 may be supplied to the inductor unit 810. A supply AC current output by the sine wave generator 830 may be controlled by the inductance of the inductor unit 810 disposed outside the controller 12. In this case, a first frequency f1 of the supply AC current may be determined by a first inductance value Li, which is an initial inductance value of an inductor L included in the inductor unit 810, as shown in Equation 1 below.

$$f 1 = \frac{1}{\sqrt{LiCi}} \qquad [ Equation 1 ]$$

Capacitance Ci of Equation 1, which is a component of a resonance tank (not shown) included in the inductor unit 810 or provided separately, may contribute to formation of a resonance frequency, and a value of the capacitance C may not change according to whether the aerosol generating article 2 is accessed. That is, the supply AC current having a resonant frequency according to the initial inductance value of the inductor L may be provided to the inductor unit 810.

The inductor unit 810 may include at least one inductor L, and may be provided separately as a component distinguished from the controller 12. The inductor unit 810 may be electrically connected to the sine wave generator 830. The inductor unit 810 may receive AC power from the sine wave generator 830, and may generate an external magnetic field, based on the AC power.

As the aerosol generating article 2 approaches the inductor L, an external magnetic field may change, and a change in the external magnetic field may cause a change in the inductance value of the inductor unit 810. According to an embodiment, the inductance value of the inductor unit 810 may be changed from a first inductance value Li, which is the initial inductance value, to a second inductance value Lf. Accordingly, a resonant frequency of an AC current flowing in the inductor unit 810 may be changed to a second frequency f2, as in Equation 2 below.

$$f 2 = \frac{1}{\sqrt{LfCi}} \qquad [ Equation 2 ]$$

The current detector 840 may be provided to detect a change in the AC current flowing in the inductor unit 810 according to this change in inductance. The current detector 840 may include at least one shunt resistor, and may obtain a sensing AC current flowing in the inductor unit 810. The current detector 840 may transmit a sensing AC current to the frequency change detector 850. According to an embodiment, the current detector 840 may include an analog-to-digital converter (ADC) that converts the sensing AC current into a digital value. According to an embodiment, the ADC may be a component included in the frequency change detector 850.

The frequency change detector 850 may detect a frequency change, based on the AC current detected by the current detector 840. To this end, the frequency change detector 850 may include a timer 851 and a counter 852. The timer 851 may measure the passage of time. The counter 852 may be provided to count the cycle of the sensing AC current.

The first operation unit 121 may determine whether the aerosol generating article 2 is included in the cavity h1, based on the frequency change of the AC current.

FIG. 9 illustrates a supply AC current 910 provided to the inductor unit 810 and a sensing AC current 920, which is an analog value obtained by the current detector 840. FIG. 9 also illustrates a supply pulse current 930 obtained by converting the supply AC current 910 into a digital value and a sensing pulse current 940 obtained by converting the sensing AC current 920 into a digital value.

The timer 851 may measure the passage of time. The supply AC current 910 may be expressed as an AC current having a first period T1 by the first inductance value Li, which is the initial inductance value of the inductor unit 810. The sensing AC current 920 may be detected as an AC current having a second period T2 by the second inductance value Lf, which is the changed inductance value of the inductor unit 810.

When the supply AC current 910 is expressed in the form of a pulse wave and the supply AC current 910 is positive, the supply AC current 910 may be expressed as high, and, when the supply AC current 910 is negative, the supply AC current 910 may be expressed as low. The same is also applied to when the sensing AC current 920 is expressed in the form of a pulse wave. In FIG. 9, a second cycle T2 of the sensing AC current 920 is shown to be shorter than a first cycle T1 of the supply AC current 910, but, according to designs, the second cycle T2 may be set to be longer than the first cycle T1.

Because a frequency is a cycle per unit time, the first operation unit 121 may determine the frequency change of the inductor unit 810, based on a change in the number of cycles per unit time. The cycle is associated with rising edges or falling edges of a pulse signal. This may be ascertained from the fact that the number of rising edges or falling edges in the cycle of each of the supply AC current 910 and the sensing AC current 920 of FIG. 9 is constant. A method of detecting a frequency change, based on falling edges, will be described below, but the controller 12 according to the disclosure may also detect a frequency change based on rising edges.

The memory 17 may store a pulse wave cycle for the supply pulse current 930. The timer 851 may measure the passage of time. The counter 852 may count the number of rising edges or falling edges of the supply pulse current 930. According to an embodiment, the counter 852 may be designed to count the number of falling edges of the supply pulse current 930. The first operation unit 121 may receive information about the passage of time from the timer 851, and may receive the number of falling edges of the supply pulse current 930 from the counter 852. The first operation unit 121 may determine a frequency change of the AC current flowing in the inductor unit 810, based on the number of falling edges per unit time.

It may be seen from FIG. 9 that the number of falling edges of the supply pulse current 930 during a unit time tr is one, while the number of falling edges of the sensing pulse current 940 during the unit time tr is two. The first operation unit 121 may determine the frequency change of the AC current flowing in the inductor unit 810, from a change in the number of falling edges per unit time. As shown in FIG. 9, in an embodiment where the number of falling edges is one in one cycle of the AC current, when the number of falling edges doubles, the first operation unit 121 may calculate that a frequency of the AC current has increased approximately twice.

The first operation unit 121 may set the frequency change of the AC current flowing in the inductor unit 810 to be the first monitoring value. The first operation unit 121 may also determine whether the aerosol generating article 2 is inserted into the cavity h1, based on the first monitoring value. When the first monitoring value exceeds a first reference range that is previously set, the first operation unit 121 may determine that the aerosol generating article 2 is inserted into the cavity h1. The first reference range may be selected from a range of 1.1 times to 10 times the frequency of the supply AC current 910, but embodiments are not limited thereto.

According to embodiments, when the first operation unit 121 determines based on the frequency change of the AC current flowing in the inductor unit 810 that the aerosol generating article 2 is inserted into the cavity h1, the first operation unit 121 may verify this determination, based on a change in the charge time period of the capacitor unit 1010.

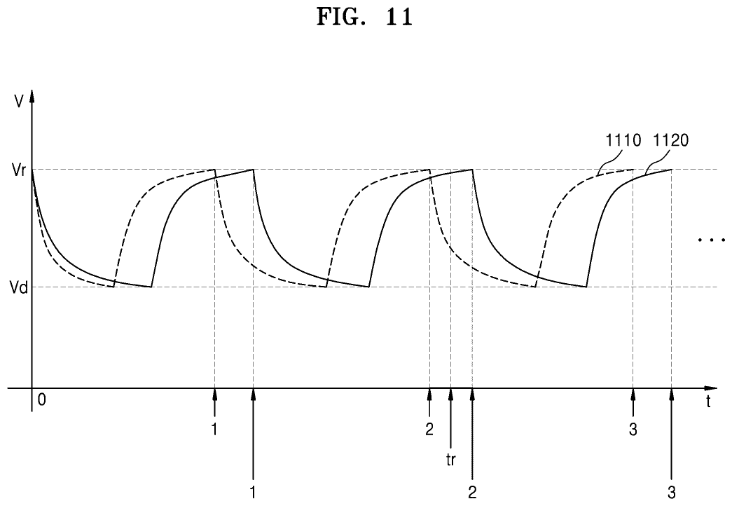

FIG. 10 is a drawing for explaining a method of obtaining a second monitoring value corresponding to a change in capacitance, according to an embodiment, and FIG. 11 is a graph for explaining a method of determining a change in a full-charge time period of FIG. 10.

Referring to FIG. 10, the controller 12 may include a power supply unit 1020, a switching unit 1030, a charging/discharging controller 1040, a charge voltage detector 1050, a full-charge time change detector 1060, and the first operation unit 121. The power supply unit 1020, the switching unit 1030, the charging/discharging controller 1040, the charge voltage detector 1050, and the full-charge time change detector 1060 may be the components included in the sharing component unit 123. In FIG. 10, the controller 12 is illustrated as mainly including components that perform operations related to obtainment of the second monitoring value. However, the controller 12 may be equipped with other components in addition to the components described above with reference to FIG. 10.

The power supply unit 1020 may provide power to the capacitor unit 1010. According to embodiments, power output by the power supply unit 1020 may be converted into an analog value and output. In this respect, the power supply unit 1020 may be referred to as a current digital-to-analog converter (CDAC or IDAC). The output of the power supply 1020 may be adjusted according to a capacitance of the capacitor unit 1010. For example, the output of the power supply unit 1020 may be adjusted at a level of 30 to 5000 nA. However, embodiments are not limited thereto, and the power supply unit 1020 may have various output levels.

The switching unit 1030 may include at least one switching elements. According to an embodiment, the switching unit 1030 may include a first switching element S1 and a second switching element S2. The second switching element S2 may be connected between the power supply unit 1020 and the capacitor unit 1010, and the second switching element S2 may be connected between the capacitor unit 1010 and a ground terminal.

The capacitor unit 1010 may include at least one capacitor C, and may be provided separately as a passive element distinguished from the controller 12. The capacitor unit 1010 may be electrically connected to the switching unit 1030, and may be charged and discharged by the switching unit 1030.

The charging/discharging controller 1040 may control the switching unit 1030 to charge and discharge the capacitor unit 1010. The charging/discharging controller 1040 may output a first switching signal Si1 and a second switching signal Si2. The first switching element S1 may be turned on or off by the first switching signal Si1. The second switching element S2 may be turned on or off by the second switching signal Si2. The first switching element S1 and the second switching element S2 may operate complementarily to each other. According to an embodiment, the charging/discharging controller 1040 may turn on the first switching element S1 and turn off the second switching element S2, in a charging mode. Accordingly, the capacitor unit 1010 may be charged by power supplied by the power supply unit 1020. The charging/discharging controller 1040 may turn on the second switching element S2 and turn off the first switching element S1, in a discharging mode. Accordingly, a voltage charged in the capacitor unit 1010 may be discharged through the ground terminal.

As the aerosol generating article 2 approaches the capacitor unit 1010, the capacitance of the capacitor section 1010 may vary. According to an embodiment, when the aerosol generating article 2 approaches the capacitor unit 1010, the capacitance may be increased by the approached aerosol generating article 2. The increase in the capacitance may be expressed as a parasitic capacitor Cs generated by the approached aerosol generating article 2 being connected in parallel to the capacitor C. When the capacitor C has a first capacitance Ci, which is an initial capacitance, and the parasitic capacitor Cs has a second capacitance Cf, a composite capacitance Ceq of the parallel-connected capacitors may be expressed as a sum of the first capacitance Ci and the second capacitance Cf, as in Equation 3 below.

C_{eq}=Ci+Cs [Equation 3]

In other words, the capacitance of the capacitor unit 1010 may increase from the first capacitance Ci, which is the initial capacitance, to the composite capacitance Ceq, which is the sum of the first capacitance Ci and the second capacitance Cf. As the capacitance of the capacitor part 1010 increases, a charge time period may increase, and it may be understood that this phenomenon is increased due to the approach of the aerosol generating article 2.

The charge voltage detector 1050 may be provided to detect a charge voltage of the capacitor unit 1010 according to this change in capacitance. The charge voltage detector 1050 may obtain the charge voltage of the capacitor unit 1010 by measuring both end voltages of the capacitor C. The charge voltage detector 1050 may transmit the obtained charge voltage to the full-charge time change detector 1060. According to an embodiment, the charge voltage detector 1050 may include an analog-to-digital converter (ADC) that again converts an analog value into a digital value. The charge voltage detector 1050 may also perform a function of controlling the output of the power supply unit 1020 according to the obtained charge voltage.

The full-charge time change detector 1060 may detect a change in a full-charge time period of the capacitor unit 1010, based on the charge voltage. To this end, the full-charge time change detector 1060 may include a comparator 1061, a timer 1062, and a counter 1063. The timer 1062 and the counter 1063 of FIG. 10 may have the same configurations as the timer 851 and the counter 852 of FIG. 8, respectively. The timer 1062 may measure the passage of time. The comparator 1061 may compare the charge voltage of the capacitor unit 1010 with a preset reference voltage and output a result of the comparison. The counter 1063 may count the number of fully charging operations of the capacitor unit 1010. The first operation unit 121 may detect a change in the full-charge time period from the number of fully-charging operations per unit time of the capacitor unit 1010, and may determine whether the aerosol generating article 2 is included in the cavity h1, based on the change in the full-charge time period.

FIG. 11 illustrates a change in the first charge voltage 1110 due to the first capacitance Ci, which is the initial capacitance of the capacitor unit 1010. FIG. 11 also illustrates a change in a second charge voltage 1120 due to a composite capacitance, which is a capacitance detected by the charge voltage detector 1050, when the aerosol generating article 2 is inserted into the cavity h1. In FIG. 11, the charge voltage is expressed as an analog value. However, the first operation unit 121 may also convert the charge voltage into a digital value to monitor the charge time period.

The timer 1062 may measure the passage of time. The first charge voltage 1110 may be pre-charged with the first capacitance Ci, which is the initial capacitance. In other words, the first charge voltage 1110 initially has a full-charge voltage Vr, and gradually discharges and decreases over time. The first charge voltage 1110 may be reduced to a preset discharge voltage Vd, and may be increased from the discharge voltage Vd back to the full-charge voltage Vr by the charging/discharging controller 1040. The first charge voltage 1110 may repeat this charging and discharging over time.

The second charge voltage 1120 may also increase to the full-charge voltage Vr in the charging mode and decrease to the discharge voltage Vd in the discharging mode. However, the first charge voltage 1110 and the second charge voltage 1120 show a difference in charge and discharge time periods.

The comparator 1061 may compare the charge voltage of the capacitor unit 1010 with a reference voltage that is previously set. The reference voltage may be set to be the full-charge voltage Vr or less. FIG. 11 illustrates an example in which the reference voltage is set to be equal to the full-charge voltage Vr, but embodiments are not limited thereto. When the charge voltage is equal to or greater than the reference voltage, the comparator 1061 may determine that the capacitor unit 1010 has been fully charged, and may output full-charge information.

The counter 1063 may count the number of times the full-charge information is output. The meaning that the counter 1063 counts the number of times the full-charge information is output may be the same as counting the number of times the capacitor unit 1010 is fully charged.

The first operation unit 121 may calculate a change in the full-charge time period of the capacitor unit 1010, based on the number of times the full-charge information is output per unit time.

The number of times the full-charge information is output per unit time for the first charge voltage 1110 may be stored in the memory 17. The number of times the full-charge information is output per unit time for the first charge voltage 1110 may be previously set by an experiment, or may be calculated by the first operation unit 121 while the aerosol generating article 2 is not being inserted into the cavity h1.

The charge voltage detector 1050 may obtain the second charge voltage 1120, which is the charge voltage of the capacitor unit 1120. The first operation unit 121 may receive the information about the passage of time from the timer 1062, and may obtain, from the comparator 1061 and the counter 1063, the number of times the full-charge information is output per unit time for the second charge voltage 1120. The first operation unit 121 may calculate a change in the full-charge time period of the capacitor unit 1010, based on the number of times the full-charge information is output per unit time for the second charge voltage 1120.

In FIG. 11, when the unit time is tr and a pre-charged initial time point 0 is excluded, the number of charging operations per unit time of the first charge voltage 1110 is 2, while the number of charging operations per unit time of the second charge voltage 1120 is reduced to 1. That is, as the capacitance of the capacitor unit 1010 increases from the first capacitance Ci to the composite capacitance Ceq, the charge time period may also increase. As shown in FIG. 11, in an embodiment where the number of charging operations per unit time is reduced by 0.5 times, the first operation unit 121 may calculate that the full-charge time period has increased by approximately two times. As such, the first operation unit 121 may determine a change in the full-charge time period from the change in the number of charging operations per unit time.

The first operation unit 121 may set the change in the full-charge time period of the capacitor unit 1010 as the second monitoring value. The first operation unit 121 may also determine whether the aerosol generating article 2 is inserted into the cavity h1, based on the second monitoring value. When the second monitoring value exceeds a second reference range, the first operation unit 121 may determine that the aerosol generating article 2 is inserted into the cavity h1. The second reference range may be selected from a range of 1.1 times to 10 times the charge time period of the capacitor C, but embodiments are not limited thereto.

The first operation unit 121 may determine insertion or non-insertion of the aerosol generating article 2, based on only a change in the charge time period of the capacitor unit 1010. Alternatively, the first operation unit 121 may determine insertion or non-insertion of the aerosol generating article 2, based on both the change in the charge time period of the capacitor unit 1010 and the frequency change of the inductor unit 810. In an embodiment utilizing both the change in the charge time period of the capacitor unit 1010 and the frequency change of the inductor unit 810, the first operation unit 121 may use the change in the charge time period of the capacitor unit 1010 to verify insertion or non-insertion of the aerosol generating article 2. In other words, the first operation unit 121 may primarily determine whether the aerosol generating article 2 is inserted, according to the frequency change of the inductor unit 810, and then may verify the primary determination, based on the change in the charge time period of the capacitor unit 1010.

The aerosol generating device 1 may also determine insertion or non-insertion of the aerosol generating article 2 by using any other determination method, besides the method of determining whether the aerosol generating article 2 is inserted, based on a change in the number of charging operations of the capacitor unit 1010 per unit time, as described in FIG. 11. Unlike the embodiment of FIG. 11, an embodiment in which the aerosol generating device 1 determines insertion or non-insertion of the aerosol generating article 2, based on a digital value (hereinafter, also referred to as a ‘unit count’) counted until the capacitor unit 1010 is fully charged will now be described.

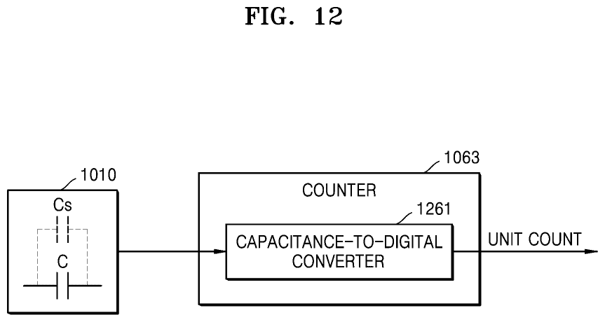

FIG. 12 is a diagram for explaining obtainment of a counting value representing a capacitance of a capacitor unit, according to an embodiment.

A counter 1063 illustrated in FIG. 12 may correspond to the counter 1063 described above with reference to FIG. 10, but may perform an operation according to another embodiment. FIG. 12 is a drawing for explaining the counter 1063 operating in a different manner from the counter 1063 of FIG. 10, and thus only the counter 1063 is illustrated in FIG. 12. However, because the power supply unit 1020, the switching unit 1030, the charging/discharging controller 1040, the charge voltage detector 1050, the comparator 1061, and the timer 1062 of FIG. 10 are omitted for convenience of explanation, the descriptions of the components given above with reference to FIG. 10 are applicable below.

Referring to FIG. 12, the counter 1063 may include a Capacitance-to-Digital Converter 1261.

Information about a change in the capacitance of the capacitor unit 1010 may be provided to the Capacitance-to-Digital Converter 1261 and converted into a counting value (Unit Counts), which is a digital value. Alternatively, because the change in the capacitance may correspond to a change in a time period taken to fully charge a capacitive sensor, the counting value may correspond to a time period taken to fully charge the capacitive sensor.

In more detail, according to an embodiment, the Capacitance-to-Digital Converter 1261 may count the number of clock signals of a certain cycle or frequency until the voltage of the capacitor unit 1010 changes from the discharge voltage Vd to the full-charge voltage Vr, to thereby convert the time period taken to fully charge the capacitor unit 1010 into a counting value and output the counting value. The counting value obtained by the counting performed by the Capacitance-to-Digital Converter 1261 may be referred to as Unit Counts. The counting value (Unit Counts) may be a value proportional to the time period taken to full-charge the capacitor unit 1010. The counting value (Unit Counts) may also be a value proportional to the capacitance (i.e., the composite capacitance) of the capacitor unit 1010. The second monitoring value described above may include the counting value output by the counter 1063.

According to another embodiment, the Capacitance-to-Digital Converter 1261 may obtain the converted counting value by using Equation 4 below.

$$Unit Count = \frac{V \cdot F}{I} \cdot C \qquad [ Equation 4 ]$$

Referring to Equation 4, ‘V’ may refer to a voltage corresponding to the full-charge voltage Vr of the capacitor C of the capacitor unit 1010. In a charging cycle of the capacitor C, the power supply unit 1020 provides a reference current IDACset for charging the capacitor C. ‘I’ may refer to the reference current IDACset, which is provided from the power supply unit 1020) to the capacitor unit 1010. ‘F’ may correspond to a frequency of one cycle in which the capacitor C is fully charged and then fully discharged (or one cycle in which the capacitor C is fully discharged and then fully charged). Accordingly, ‘F’ may be associated with on/off time periods of the first switching element S1 and the second switching element S2. ‘C’ may correspond to the composite capacitance Ceq of the capacitor unit 1010. Therefore, according to Equation 4, when ‘V’, ‘l’, and ‘F’ are constant, the counting value may be a value that is dependent on the composite capacitance Ceq of the capacitor unit 1010. Equation 4 may correspond to an embodiment for obtaining the counting value, when the power supply unit 1020 includes a single current source IDAC.

According to another embodiment, the Capacitance-to-Digital Converter 1261 may obtain the converted counting value by using Equation 5 below.

$$Unit Count = \frac{V \cdot F}{{I}_{gain}} \cdot C - \frac{{I}_{offset}}{{I}_{gain}} \qquad [ Equation 5 ]$$

Referring to Equation 5, ‘V’ may refer to a voltage corresponding to the full-charge voltage Vr of the capacitor C of the capacitor unit 1010. ‘Igain’ and ‘Ioffset’ may refer to the reference current IDACset provided from each current source to the capacitor unit 1010, when the power supply unit 1020 includes a dual current source (IDAC 1 and IDAC 2). ‘F’ may correspond to a frequency of one cycle in which the capacitor C is fully charged and then fully discharged (or one cycle in which the capacitor C is fully discharged and then fully charged). ‘C’ may correspond to the composite capacitance Ceq of the capacitor unit 1010. Therefore, according to Equation 5, when ‘V’, ‘Igain’, ‘Ioffset’, and ‘F’ are constant, the counting value may be a value that is dependent on the composite capacitance Ceq of the capacitor unit 1010.

The counting value (Unit Counts) being relatively large may indicate that a time period taken for fully charging until the voltage of the capacitor unit 1010 changes from the discharge voltage Vd to the full-charge voltage Vr is relatively long. On the other hand, the counting value (Unit Counts) being relatively small may indicate that the time period taken for fully charging until the voltage of the capacitor unit 1010 changes from the discharge voltage Vd to the full-charge voltage Vr is relatively short.

As such, the information about the change in the capacitance of the capacitor unit 1010 may be converted into the counting value (Unit Counts), and, based on a level of the counting value (Unit Counts), a determination as to whether the aerosol generating article 2 is inserted may be made.

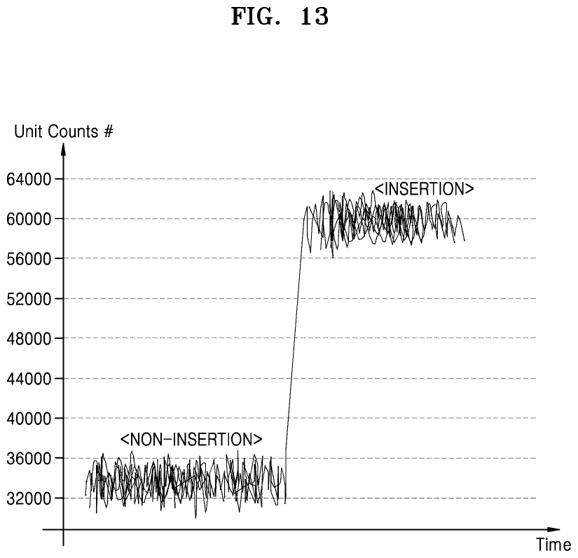

FIG. 13 is a graph for explaining a relationship between the counting value (Unit Counts) and the full-charge time period, according to an embodiment.

Referring to FIG. 13, because the parasitic capacitor Cs does not exist when the aerosol generating article 2 is not inserted, the capacitor unit 1010 has only the first capacitance Ci, which is the initial capacitance. The counting value (Unit Counts) obtained until the capacitor unit 1010 changes from the discharge voltage Vd to the full-charge voltage Vr when the aerosol generating article 2 is not inserted may be within a range of about 32,000 to about 35,000.

The controller 12 may obtain the counting value from the counter 1063 every time a charging/discharging cycle of the capacitor unit 1010 is completed. The controller 12 may previously set a range of counting values corresponding to a non-insertion state, and, when the counting value output by the counter 1063 falls within this preset range, may determine that the aerosol generating article 2 has not yet been inserted.

However, as a result of monitoring the counting value at a certain charging/discharging cycle, the counting value may be approximately 60,000. When the aerosol generating article 2 is inserted, the second capacitance Cf due to the parasitic capacitor Cs is added to the first capacitance Ci, so it may take a longer time for the capacitor unit 1010 to change from the discharge voltage Vd to the full-charge voltage Vr. Accordingly, the counting value (Unit Counts) may be increased to a level of approximately 60,000.

The controller 12 may previously set a range of counting values corresponding to an insertion state, and, when the counting value output by the counter 1063 falls within this preset range, may determine that the aerosol generating article 2 is inserted.

That is, when the controller 12 wants to determine insertion or non-insertion of the aerosol generating article 2, based on the change in the capacitance of the capacitor unit 1010, the controller 12 may perform the determination by using a change in the counting value output by the counter 1063.

Numerical values of the counting value described above with reference to FIG. 13 are only exemplary, and the present embodiment is not limited thereto. The counting value may be expressed as various other numerical values according to settings of the counter 1063.

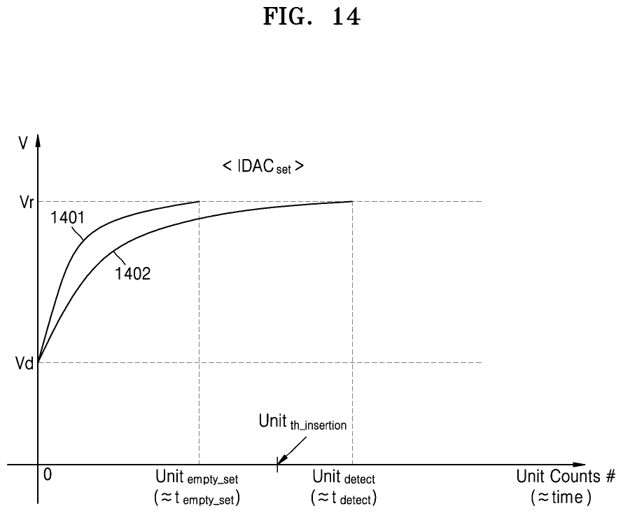

FIG. 14 is a graph for explaining a method of determining insertion or non-insertion of an aerosol generating article by using a counting value representing a change in capacitance, according to an embodiment.

Referring to FIG. 14, a graph 1401 represents a voltage change of the capacitor unit 1010 in a state where the aerosol generating article 2 is not inserted (non-insertion state), and a graph 1402 represents a currently-monitored voltage change. The voltage change of the capacitor unit 1010 may refer to a change from the discharge voltage Vd to the full-charge voltage Vr.

Referring to the graph 1401, a counted value obtained until the voltage of the capacitor unit 1010 changes from the discharge voltage Vd to the full-charge voltage Vr in the non-insertion state is Unitempty_set. Unitempty_set may refer to a value proportional to a full-charge time period tempty_set when the aerosol generating article 2 is inserted. Therefore, Unitempty_set may be set to correspond to a reference counting value indicating a non-insertion state.

Referring to graph 1402, the counted value according to the change in the currently-monitored voltage change is Unitdetect. Comparing the graph 1402 with the graph 1401, a larger counting value Unitdetect was output, which may mean that a longer full-charge time period tdetect was taken. In other words, the graph 1402 may indicate that other capacitance has been added in addition to the initial capacitance of the capacitor unit 1010.

In order to determine whether the voltage change according to the graph 1402 is due to the insertion of the aerosol generating article 2, a threshold value Unitth_insertion may be previously set. That is, when a currently-output counting value exceeds the threshold value Unitth_insertion, the controller 12 may determine that the aerosol generating article 2 is inserted.

In FIG. 14, because the currently-output counting value Unitdetect exceeds the threshold value Unitth_insertion, the controller 12 may determine that the aerosol generating article 2 is inserted at a time point when the currently-output counting value Unitdetect is output.

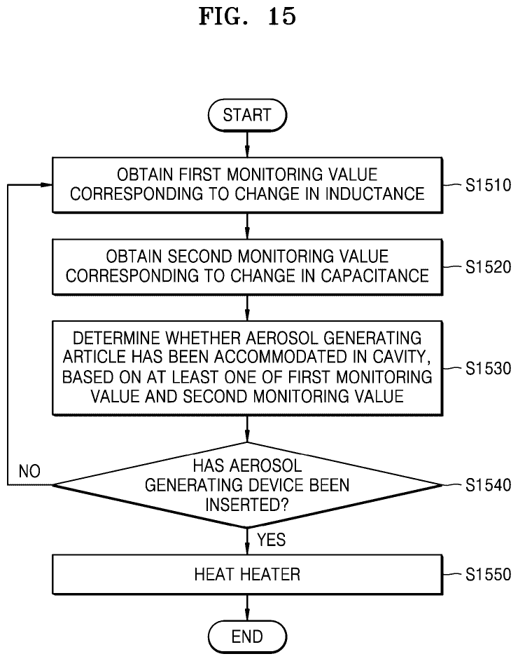

FIG. 15 is a flowchart of an operation method of an aerosol generating device, according to an embodiment.

Referring to FIG. 15, in operation S1510, the controller 12 may obtain a first monitoring value corresponding to a change in inductance.

The aerosol generating device 1 may include the inductor unit 810 as a component distinguished from the controller 12, and an inductance value of the inductor unit 810 may vary as the aerosol generating article 2 approaches the inductor unit 810. As the inductance value of the inductor unit 810 varies, the frequency of the AC current flowing in the inductor unit 810 may also vary. The first operation unit 121 in the controller 12 may use the sharing component unit 123 to detect the change in the frequency of the AC current.

The current detector 840 in the sharing component unit 123 may detect the AC current flowing in the inductor unit 810. The current detector 840 may transmit information about the AC current to the frequency change detector 850.

The frequency change detector 850 may include a timer 851 and a counter 852. The current detector 840 or the frequency change detector 850 may include an ADC that converts the information about the AC current into a digital value, and the frequency change detector 850 may count rising edges or falling edges of the AC current over time.

The number of rising edges of the AC current per unit time or the number of falling edges of the AC current per unit time may be equal to the cycle of the AC current per unit time, and the first operation unit 121 may calculate the frequency change of the AC current, based on the number of rising edges of the AC current per unit time or the number of falling edges of the AC current per unit time. The memory 17 may store a first frequency of the AC current due to the first inductance value Li, which is the initial inductance value of the inductor unit 810, and the first operation unit 121 may obtain a second frequency of the AC current due to the second inductance value Lf, which is a current inductance value of the inductor unit 810.

The first operation unit 121 may obtain the frequency change of the AC current by comparing the first frequency with the second frequency. The frequency change of the AC current may be obtained as the first monitoring value by the first operation unit 121.

In operation S1520, the controller 12 may obtain a second monitoring value corresponding to a change in capacitance.

The aerosol generating device 1 may include the capacitor unit 1010 as a component distinguished from the controller 12, and capacitance of the capacitor unit 1010 may vary as the aerosol generating article 2 approaches the capacitor unit 1010.

As the capacitance of the capacitor unit 1010 varies, the full-charge time period of the capacitor unit 1010 may also vary. The first operation unit 121 in the controller 12 may use the sharing component unit 123 to detect the change in the full-charge time period of the capacitor unit 1010.

The charge voltage detector 1050 in the sharing component unit 123 may detect the charge voltage of the capacitor unit 1010. The charge voltage detector 1050 may transmit information about the charge voltage to the full-charge time change detector 1060.

The full-charge time change detector 1060 may include a comparator 1061, a timer 1062, and a counter 1063. According to embodiments, the charge voltage detector 1050 or the charging time change detector 1060 may include an ADC that converts an analog value back to a digital value.

The comparator 1061 may compare the charge voltage of the capacitor unit 1010 with a reference voltage that is previously set. When the charge voltage is equal to or greater than the reference voltage, the comparator 1061 may determine that the capacitor unit 1010 has been fully charged, and may output full-charge information. The timer 1062 may measure the passage of time.

The counter 1063 according to an embodiment may count the number of times the full-charge information is output over time. The meaning that the counter 1063 counts the number of times the full-charge information is output may be the same as counting the number of times the capacitor unit 1010 is fully charged. The number of times of fully charging per unit time may correspond to a charge time period, and the first operation unit 121 may calculate a change in the full-charge time period of the capacitor unit 1010, based on the number of full-charge voltages per unit time. The memory 17 may store a first full-charge frequency per unit time of the capacitor unit 1010 due to a first capacitance, which is the initial capacitance of the capacitor unit 1010. The first operation unit 121 may obtain a second full-charge frequency per unit time of the capacitor unit 1010 due to a second capacitance, which is the current capacitance of the capacitor unit 1010.

The first operation unit 121 may obtain a change in the full-charge time period of the capacitor unit 1010 by comparing the first full-charge frequency with the second full-charge frequency. The change in the full-charge time period may be obtained as the second monitoring value by the first operation unit 121.

According to another embodiment, the counter 1063 may count the full-charge time period of the capacitor unit 1010, based on the full-charge information. The counter 1063 may convert a time period taken until the voltage of the capacitor unit 1010 changes from a discharge voltage to a full-charge voltage into a counting value and output the counting value. The memory 17 may store a first full-charge time period of the capacitor unit 1010 due to the first capacitance, which is the initial capacitance of the capacitor unit 1010. The second operation unit 121 may obtain a second full-charge time period of the capacitor unit 1010 due to the second capacitance, which is the current capacitance of the capacitor unit 1010.

The first operation unit 121 may obtain the change in the full-charge time period of the capacitor unit 1010 by comparing the first full-charge time period with the second full-charge time period. The change in the full-charge time period may be obtained as the second monitoring value by the first operation unit 121.

As such, the counter 1063 may count the full-charge frequency or full-charge time period of the capacitor unit 1010, based on the full-charge information output by the comparator 1061, and the first operation unit 121 may calculate the change in the full-charge time period of the capacitor unit 1010 corresponding to the second monitoring value, based on the full-charge frequency or full-charge time period of the capacitor unit 1010. A more detailed method, performed by the counter 1063, of obtaining the second monitoring value, based on the full-charge frequency of the capacitor unit 1010 is the same as that described above with reference to FIGS. 10 and 11. A more detailed method, performed by the counter 1063, of obtaining the second monitoring value, based on the full-charge time period of the capacitor unit 1010 is the same as that described above with reference to FIGS. 12 through 14.

In operation S1530, the controller 12 may determine whether the aerosol generating article 2 is accommodated in the cavity h1, based on at least one of the first monitoring value and the second monitoring value.

A function of determining whether the aerosol generating article 2 is accommodated in the cavity h1 may be performed by the first operation unit 121 within the controller 12.

When the first monitoring value exceeds a first reference range that is previously set, the first operation unit 121 may determine that the aerosol generating article 2 is inserted into the cavity h1. For example, when the first reference range is selected as a range of 1.1 to 2 times the first frequency, the first operation unit 121 may determine that the aerosol generating article 2 is inserted into the cavity h1, when the second frequency exceeds twice the first frequency.

When the second monitoring value exceeds a second reference range that is previously set, the second operation unit 122 may determine that the aerosol generating article 2 is inserted into the cavity h1. For example, when the second reference range is set as a range of 1.1 times to 2 times a first charge time period according to the initial capacitance of the capacitor unit 1010, the first operation unit 121 may determine that the aerosol generating article 2 is inserted into the cavity h1, when a second charge time period according to the current capacitance of the capacitor unit 1010 exceeds twice the first charge time period.

In an embodiment where both the first monitoring value and the second monitoring value are used to determine insertion or non-insertion of the aerosol generating article 2, the second monitoring value may be used to verify a primary determination. For example, the first operation unit 121 may primarily determine whether the aerosol generating article 2 is inserted, according to the frequency change of the inductor unit 810, and then may verify the primary determination, based on the change in the charge time period of the capacitor unit 1010.

In operation S1540, the controller 12 may finally determine insertion or non-insertion of the aerosol generating article 2.

When the first operation unit 121 determines that the aerosol generating article 2 is not inserted into the cavity h1, the method may be fed back to operation S1210 to obtain the first monitoring value again.

When the first operation unit 121 determines that the aerosol generating article 2 is inserted into the cavity h1, the first operation unit 121 may output a wake-up signal. The wake-up signal may be provided to the second operation unit 122. When the second operation unit 122 receives the wake-up signal, the second operation unit 122 may switch from a sleep mode state to a wakeup state.

In operation S1550, the controller 12 may heat the heater 18.

The heating of the heater 18 may be controlled by the second operation unit 122 within the controller 12. At least one of a clock speed and an interrupt processing frequency of the second operation unit 122 may be higher than that of the first operation unit 121. According to an embodiment, a clock frequency of the second operation unit 122 may be set to be greater than a clock frequency of the first operation unit 121. For example, the second operation unit 122 may be set with a clock frequency of 100 MHZ, and the first operation unit 121 may be set with a clock frequency of 48 MHz. Accordingly, an active time period of the second operation unit 122 may be set to be greater than an active time period of the first operation unit 121. In this case, the active time period may refer to an operating time period. Thus, power consumption of the second operation unit 122 may be greater than power consumption of the first operation unit 121.

When the aerosol generating article 2 is accommodated into the cavity h1, the second operation unit 122 may automatically heat the heater 18 without a user input.

The aerosol generating device 1 according to the disclosure may determine insertion or non-insertion of the aerosol generating article 2, which is a relatively simple operation, through the first operation unit 121 providing low performance but low power consumption, and the second operation unit 122 that is high in performance and consumes much power may be used to control the heater 18, leading to an increase in energy efficiency, as compared to a conventional aerosol generating device equipped with a single operation unit.

Certain embodiments or other embodiments of the disclosure described above are not exclusive or distinct from each other. The certain embodiments or other embodiments of the disclosure described above may be combined with each other or used in combination with each other in their respective components or functions.

For example, it means that an A component described in a specific embodiment and/or the drawings and a B component described in another embodiment and/or the drawings may be combined with each other. In other words, even when it is not explained directly about combination between components, it is possible to combine unless it is explained that combination is impossible.

The above detailed description should not be interpreted restrictively and should be considered illustrative, in all aspects. The scope of the disclosure should be determined by a rational interpretation of the attached claims, and all changes within the equivalent scope of the disclosure are included in the scope of the disclosure.

Because the aerosol generating device 1 according to the disclosure determines insertion or non-insertion of the aerosol generating substrate by considering not only a change in the inductance but also a change in the capacitance, detection accuracy of the aerosol generating substrate may be significantly increased.

In addition, the aerosol generating device includes, in a processor, components for determining changes in inductance and capacitance, leading to a significant increase in power consumption, as compared to a case where an inductive sensor and a capacitive sensor are separately included.

Moreover, the processor includes a plurality of cores, and a low-power core among the plurality of cores is designed to determine both the change in inductance and the change in capacitance, thereby significantly reducing power consumption.

In addition, peripheral components for determining the change in inductance and peripheral components for determining the change in capacitance may be included as shared components in the processor, and the low-power core determines the change by using at least one of the shared components, as needed, thereby exhibiting an integrated design and a low-power design.

The effects of the disclosure are not limited to those exemplified above, and more diverse effects are included in this specification.

What is claimed is:

1. An aerosol generating device comprising:
a heater configured to heat an aerosol generating article accommodated in a cavity;
an inductor unit including at least one inductor surrounding at least a portion of the cavity, and having an inductance that varies when the aerosol generating article is accommodated in the cavity;
a capacitor unit including at least one capacitor surrounding a remaining portion of the cavity, and having a capacitance that varies when the aerosol generating article is accommodated in the cavity; and
a controller configured to obtain a first monitoring value corresponding to a change in the inductance and a second monitoring value corresponding to a change in the capacitance, and, based on at least one of the first monitoring value and the second monitoring value, determine whether the aerosol generating article is accommodated in the cavity.

2. The aerosol generating device of claim 1, wherein
the controller comprises:
a square wave oscillator configured to generate a square wave; and
a sine wave generator configured to generate alternating current (AC) power of a sine wave, based on the square wave output by the square wave generator, and
the inductor unit is electrically connected to the square wave generator to receive the AC power, and configured to generate an external magnetic field, based on the AC power.

3. The aerosol generating device of claim 2, wherein
the inductance of the inductor unit varies as the aerosol generating article approaches the inductor unit.

4. The aerosol generating device of claim 3, wherein the controller further comprises:
a current detector configured to detect a change in the AC current flowing in the inductor unit according to a change in the inductance; and
a frequency change detector configured to detect a change in frequency of the AC current, based on the AC current detected by the current detector.

5. The aerosol generating device of claim 4, wherein the frequency change detector comprises:
a timer; and
a counter configured to count rising edges or falling edges of the AC current.

6. The aerosol generating device of claim 5, wherein
the controller further comprises a first operation unit configured to calculate the change in the frequency of the AC current, based on a number of rising edges of the AC current per unit time or a number of falling edges of the AC current per unit time, and
the first operation unit is further configured to determine whether the aerosol generating article is inserted into the cavity, based on the change in the frequency of the AC current corresponding to the first monitoring value.

7. The aerosol generating device of claim 1, wherein the controller comprises:
a power supply configured to provide power to the capacitor unit;
a switching unit connected to the power supply and including at least one switching element; and
a charging/discharging controller configured to control the switching unit to charge and discharge the capacitor unit.

8. The aerosol generating device of claim 7, wherein the capacitance of the capacitor unit varies as the aerosol generating article approaches the capacitor unit.

9. The aerosol generating device of claim 8, wherein the controller further comprises:
a charge voltage detector configured to detect a charge voltage of the capacitor unit according to a change in the capacitance; and
a full-charge time change detector configured to detect a change in a full-charge time period of the capacitor unit, based on the charge voltage.

10. The aerosol generating device of claim 9, wherein the full-charge time change detector comprises:
a comparator configured to compare the charge voltage of the capacitor unit with a preset reference voltage and, when the charge voltage is equal to or greater than the preset reference voltage, determine that the capacitor unit has been fully charged and output full-charge information;
a timer; and
a counter configured to count a full-charge frequency or full-charge time period of the capacitor unit, based on the full-charge information output by the comparator.

11. The aerosol generating device of claim 10, wherein
the controller further comprises a first operation unit configured to calculate a change in the full-charge time period of the capacitor unit, based on the full-charge frequency or full-charge time period of the capacitor unit; and
the first operation unit is further configured to determine whether the aerosol generating article is inserted into the cavity, based on the change in the full-charge time period corresponding to the second monitoring value.

12. The aerosol generating device of claim 1, wherein the controller comprises a first operation unit configured to determine whether the aerosol generating article is accommodated in the cavity, and a second operation unit configured to control operation of the heater.

13. The aerosol generating device of claim 12, wherein the first operation unit is further configured to determine that the aerosol generating article is accommodated in the cavity, when the first monitoring value exceeds a preset first reference range and a second monitoring value exceeds a preset second reference range.

14. The aerosol generating device of claim 12, wherein
when the first operation unit determines that the aerosol generating article is accommodated in the cavity, the first operation unit outputs a wake-up signal, and
the second operation unit is woken up by the wake-up signal and heats the heater.

15. The aerosol generating device of claim 12, wherein power consumption of the first operation unit is less than power consumption of the second operation unit.
